(19) United States
(12) Patent Application Publication
(10) Pub. No.: US 2015/0234773 A1
(43) Pub. Date: Aug. 20, 2015

(54) TECHNIQUE TO AVOID METASTABILITY CONDITION AND AVOID UNINTENTIONAL STATE CHANGES OF LEGACY I2C DEVICES ON A MULTI-MODE BUS

(71) Applicant: QUALCOMM Incorporated, San Diego, CA (US)

(72) Inventor: Shoichiro Sengoku, San Diego, CA (US)

(21) Appl. No.: 14/625,567

(22) Filed: Feb. 18, 2015

Related U.S. Application Data
(60) Provisional application No. 61/941,391, filed on Feb. 18, 2014.
(60) Provisional application No. 61/941,384, filed on Feb. 18, 2014.

(51) Int. Cl. G06F 13/42

(52) U.S. Cl. CPC G06F 13/4291; G06F 13/4221

(57) ABSTRACT

A device may include an interface to couple to a multi-mode bus shared with one or more I2C-compatible devices. The bus may include a first line and a second line, wherein in a first mode of operation the first line transmits data and the second line transmits a clock, while in a second mode of operation the first and second lines are both used to transmit data. The device may also include a transmitter to transmit data over the bus (SDA line 3204 and SCL line 3206) as a sequence of pulses within symbol slots. In the second mode of operation a transmission period of a first symbol slot is stretched to prevent the I2C-compatible devices from changing into an unpredictable state as a result of a transition from a first pulse to a second pulse.

### CROSS-REFERENCE TO RELATED APPLICATIONS

The present application for Patent claims priority to Provisional Application No. App. No.: 61/941,391, entitled “Method to Avoid Metastability Condition of Legacy I2C Devices on Camera Control Interface Extension (CCIe)-compatible Bus” filed Feb. 18, 2014, and Provisional Application No. App. No.: 61/941,384, entitled “Technique to Avoid Unintentional State Changes in Legacy I2C Devices Sharing a Camera Control Interface Extension (CCIe)-Compatible Bus”, filed Feb. 18, 2014 all of which are assigned to the assignee hereof and hereby expressly incorporated by reference herein.

### FIELD

The present disclosure pertains to techniques to permit devices of different generations to coexist when coupled to a shared bus and, more particularly, to permit I2C-compatible devices to coexist with CCIe-compatible devices on the shared bus.

### BACKGROUND

I2C (also referred to as I²C) is a multi-master serial single-ended bus used for attaching low-speed peripherals to a motherboard, embedded system, cellphone, or other electronic devices. The I2C bus includes a clock (SCL) and data (SDA) lines with 7-bit addressing. The bus has two roles for devices: master and slave. A master device is a node that generates the clock and initiates communication with slave devices. A slave device is a node that receives the clock and responds when addressed by the master device. The I2C bus is a multi-master bus which means any number of master devices can be present. Additionally, master and slave roles may be changed between messages (after a STOP is sent). I2C defines basic types of messages, each of which begins with a START and ends with a STOP.

In this context of a camera implementation, unidirectional transmissions may be used to capture an image from a sensor and transmit such image data to memory in a baseband processor, while control data may be exchanged between the baseband processor and the sensor as well as other peripheral devices. In one example, a Camera Control Interface (CCI) protocol may be used for such control data between the baseband processor and the image sensor (and/or one or more slave devices). In one example, the CCI protocol may be implemented over an I2C serial bus between the image sensor and the baseband processor.

An extension to CCI called CCIe (Camera Control Interface extended) has been developed that encodes information for transmission over the shared bus. CCIe does not implement a separate clock line on the shared bus. Instead, it embeds a clock within the transmitted transcoded information.

Since CCIe devices transmit information over both data lines of a bus instead of a single data line as expected by I2C devices, CCIe transmissions are configured to periodically reset the interface logic of I2C devices (e.g., reset interfaces for I2C receivers and/or I2C device state machines, etc.) and thereby prevent I2C devices from actually processing any information over the shared bus. However, since data is transmitted on the clock line of the two line bus used by I2C devices, not just the data line, combinational logic within I2C devices may change states unpredictably. Such change in states may cause the I2C devices to, for example, start transmitting information over the shared bus at the wrong time. Additionally, because data transmissions occur on both lines of the shared bus, combinational logic within I2C devices may inadvertently enter into an unwanted metastable state when both bus lines change states at the same time.

Therefore, a solution is needed that allows I2C-compatible devices and CCIe-compatible devices to coexist on a shared bus.

### SUMMARY

In one example, a device may include an interface to couple to a multi-mode bus shared with one or more I2C-compatible devices. The bus may include a first line and a second line, wherein in a first mode of operation the first line transmits data and the second line transmits a clock, while in a second mode of operation the first and second lines are both used to transmit data. The device may also include a transmitter to transmit data over the bus (SDA line and SCL line) as a sequence of pulses within symbol slots. In the second mode of operation a transmission period of a first symbol slot is stretched to prevent the I2C-compatible devices from changing into an unpredictable state as a result of a transition from a first pulse to a second pulse.

In one example, the first symbol slot may be stretched so that a perceived period of time without a state change by the bus at the I2C-compatible devices is at least a minimum first threshold period of time. For instance, the first symbol slot may be stretched in the second mode of operation to prevent a state change on the second line, as perceived by the I2C-compatible devices, for a minimum first threshold period of time. The minimum first threshold period of time may correspond to a minimum period of time that I2C-compatible devices can reliably detect state changes over the bus.

In one implementation, two state changes over the bus occurring within less than a second threshold period of time (e.g., a pulse of 50 ns or less) are filtered out by I2C-compatible devices while avoiding stretching of a symbol slot. Additionally, the transmitting device may be aware of such short pulse filtering at the I2C devices and intelligently stretches symbols. In particular, the device may avoid stretching a symbol if it knows that a subsequent pulse will be filtered out by the receiving I2C devices.

The device may also include a processing circuit (e.g., logic circuit or control logic) coupled to the transmitter. The processing circuit may serve to ascertain one or more characteristics of the with one or more I2C-compatible devices coupled to the bus. If all I2C-compatible devices coupled to the bus are synchronously designed with a fast clock, symbol stretching of any symbol slot is avoided (i.e., there is no need for symbol stretching if the I2C device receiver clock is sufficiently fast).

According to another aspect, the device may avoid concurrent state changes on both the first line and second line are avoided to prevent a metastable condition on any I2C devices coupled to the bus. If no I2C-compatible devices are coupled to the bus, the transmitter may be further configured to transmit data signals, according to the second mode, over the first line and second line of the bus as a sequence of pulses within symbol slots, but using concurrent state changes on both the first line and second line.

In one example, if all I2C-compatible devices coupled the bus are synchronously designed with an internal clock, the transmitter may be further configured to transmit data signals, according to the second mode, over the first line and second line of the bus as a sequence of pulses within symbol slots, but using concurrent state changes on both the first line and second line.

In one example, where no I2C devices are coupled to the bus, the transmitter transmits data signals with concurrent state changes over the first and second lines using 12 symbols of 3 states per symbol. In another example, where I2C devices are coupled to the bus, the transmitter transmits data signals that avoid concurrent state changes on the first and second lines using 20 symbols of 2 states per symbol.

### DRAWINGS

Various features, nature, and advantages may become apparent from the detailed description set forth below when taken in conjunction with the drawings in which like reference characters identify correspondingly throughout.

FIG. 1 is a block diagram illustrating an example of a bus shared by I2C-compatible devices (i.e., legacy devices) and CCIe-compatible devices.

FIG. 2 is a block diagram illustrating a device having a baseband processor and an image sensor and implementing an image data bus and a multi-mode control data bus.

FIG. 3 illustrates a timing diagram of an I2C one byte write data operation.

FIG. 4 illustrates the effect a START condition has on a legacy I2C slave node.

FIG. 5 illustrates the number of clock toggles may be transmitted between two START conditions, and thereby the number of symbols that may be transmitted.

FIG. 6 illustrates how both wires/lines of an I2C bus may be utilized for data transmission in CCIe mode.

FIG. 7 illustrates an exemplary state machine for an I2C device.

FIG. 8 illustrates how as the symbol transmission period on the clock line of the bus gets shorter, the state machine transitions may unpredictably change.

FIG. 9 illustrates one possible solution to preventing an I2C device state machine from changing during CCIe transmission on the shared bus.

FIG. 10 illustrates that symbol periods less than a threshold period (e.g., 50 ns) are filtered by input filters on the SDA line and SCL line.

FIG. 11 illustrates how some symbols may be filtered by the input filters of an I2C device receiver.

FIG. 12 illustrates how, CCIe mode, some symbols on the SCL line may be selectively stretched so that unwanted state changes do not occur on the I2C device.

FIG. 13 illustrates the best and worst case data throughput for the approach in which certain symbol periods are selectively stretched.

FIG. 14 illustrates a technique for a CCIe transmitter to track when a symbol (in low state) should be stretched.

FIG. 15 illustrates another example in which symbol slots are selectively stretched during a transmission by the transmitting CCIe device.

FIG. 16 illustrates yet another example in which two symbol slots are stretched during a transmission by the transmitting CCIe device.

FIG. 17 illustrates yet another example in which two symbols slots are stretched during a transmission by the transmitting CCIe device.

FIG. 18 illustrates a method operational on a CCIe-compatible device.

FIG. 19 illustrates the conditions under which a metastable state may occur. That is, when both the data line (SDA) and the clock line (SCL) change at the same time, then a metastable condition may occur at I2C devices.

FIG. 20 illustrates the occurrence of a metastable condition when both the SDA and SCL lines change states at the same time.

FIG. 21 illustrates the conditions that must be avoided to prevent an unintended START or STOP condition.

FIG. 22 illustrates that the transitions between symbols that cause metastable conditions may be eliminated, but now 20 bits per word are sent in order to increase the effective data throughput.

FIG. 23 illustrates a comparison between a first transmission scheme using 12 symbols of 3 states per symbol and a second transmission scheme using 20 symbols of 2 states per symbol.

FIG. 24 illustrates the fastest and slowest rate scenarios for a CCIe transmission in which 20 symbol (with 2 states per symbol) are used between two START indicators, without including overhead bits.

FIG. 25 illustrates a method operational on a CCIe-compatible device for avoiding metastable conditions of I2C-compatible devices coupled to a shared bus.

FIG. 26 is a block diagram illustrating an exemplary method for transcoding of data bits into transcoded symbols at a transmitter to embed a clock signal within the transcoded symbols.

FIG. 27 illustrates an exemplary conversion from bits to transition numbers at a transmitter and then from transition numbers to bits at a receiver.

FIG. 28 illustrates one example of converting between ternary numbers (transition number) and (sequential) symbols.

FIG. 29 illustrates the conversion between sequential symbols and transition numbers.

FIG. 30 illustrates the receiver that is configured to write data received over a shared bus to registers using only a clock recovered from the received data (i.e., no free-running clock is required).

FIG. 31 illustrates circuits for converting a twelve digit ternary number into bits and achieving a register write operation of extracted bits using only the recovered clock.

FIG. 32 illustrates an exemplary CCIe slave device configured to receive a transmission from a shared bus by using a clock extracted from the received transmission and writing data from the transmission without the need for the slave device to be awake.

FIG. 33 illustrates a general example of converting a ternary number (base-3 number) to a binary number, where each T in {T11, T10, . . . T2, T1, T0} is a symbol transition number.

FIG. 34 illustrates an exemplary method for converting a binary number (bits) to a 12 digit ternary number (base-3 number).

FIG. 35 illustrates an example of one possible implementation of the division and the module operations of the FIG. 34, which may be synthesizable by any commercial synthesis tools.

FIG. 36 illustrates yet another example in which a symbol slot is stretched during a transmission by a transmitting CCIe device to facilitate coexistence with I2C devices on a shared multi-mode bus.

FIG. 37 illustrates yet another example in which a symbol slot is stretched during a transmission by a transmitting CCIe device.

FIG. 38 illustrates another example in which a transmitting CCIe device includes a mock filter similar to those of I2C devices to more efficiently implement symbol stretching.

FIG. 39 illustrates an exemplary logic circuit implementing look ahead symbol stretching in CCIe device to facilitate coexistence with I2C devices on a shared multi-mode bus.

FIG. 40 illustrates another example in which a transmitting CCIe device includes a mock filter similar to those of I2C devices to more efficiently implement symbol stretching.

### DETAILED DESCRIPTION

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures, and techniques may not be shown in detail in order not to obscure the embodiments.

### Overview

A shared multi-mode bus is provided in which, for example, I2C-compatible devices coexist with other types of devices. For example, the shared bus may include a first line and a second line, wherein in a first mode of operation the first line transmits data and the second line transmits a clock, while in a second mode of operation the first and second lines are both used to transmit data. However, in the second mode of operation, steps must be taken to prevent adversely affecting devices that only operate according to the first mode (e.g., I2C-compatible device).

A first feature prevents combinational logic within I2C-compatible devices from causing undesired state changes (e.g., changing to an unpredictable state) due to data transmissions over a clock line of a bus shared by the I2C devices and other devices (e.g., CCIe-compatible devices). In particular, while operating the shared bus in a non-I2C mode, if there is a change in signal states on the clock line that may cause an I2C-compatible device to unintentionally change the state(s) of its sequential combinational logic, a transmission period is stretched to prevent the sequential combinational logic of I2C-compatible devices from changing states.

A second feature prevents the sequential combinational logic of I2C-compatible devices from entering into a metastable state upon occurrence of data transmissions on the shared bus in which both lines change at the same time (e.g., concurrently or simultaneously). In particular, transmissions during the non-I2C mode in which both lines change states at the same time are prohibited.

### Exemplary Operating Environment

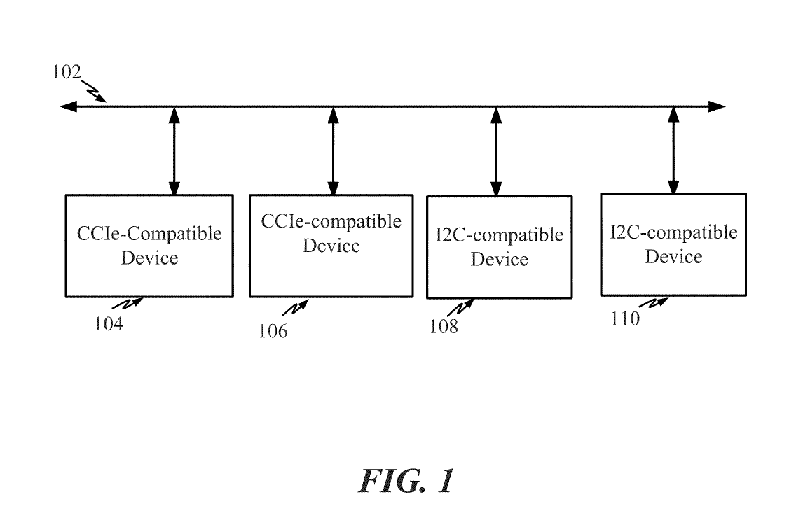

FIG. 1 is a block diagram illustrating an example of a bus 102 shared by I2C-compatible devices 108 and 110 (i.e., legacy devices) and CCIe-compatible devices 104 and 106. The bus 102 may be a two-line bus. In I2C operation, the two bus lines are used for data (SDA line) and a clock (SCL line). In CCIe operation both bus lines (SDA line and SCL line) are used to for data transmissions while a clock is embedded within symbol-to-symbol transitions.

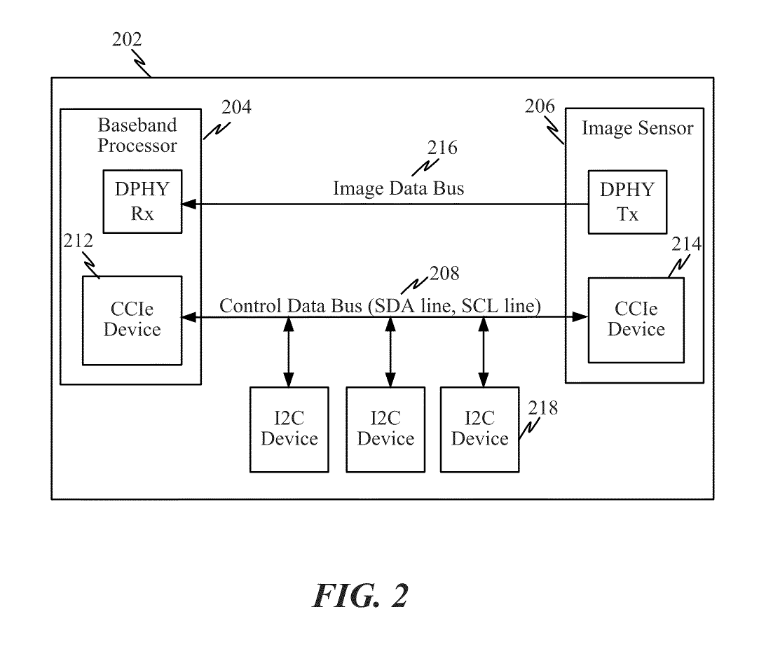

FIG. 2 is a block diagram illustrating a device 202 having a baseband processor 204 and an image sensor 206 and implementing an image data bus 216 and a multi-mode control data bus 208. The control data bus 208 may be implemented in various different devices and/or systems (e.g., camera, mobile phone, etc.). Image data may be sent from the image sensor 206 to the baseband processor 204 over an image data bus 216 (e.g., a high speed differential DPHY link). In one example, the control data bus 208 may comprise two wires, for example, a clock line (SCL) and a serial data line (SDA). In I2C mode, the clock line SCL may be used to synchronize all data transfers over the control data bus 208. The data line SDA and clock line SCL are coupled to all devices 212, 214, and 218 on the control data bus 208. In this example, control data may be exchanged between the baseband processor 204 and the image sensor 206 as well as other peripheral devices 218 via the control data bus 208.

In one example, the control data bus 208 may be shared (e.g., concurrently used) by one or more I2C-compatible devices 218 as well as CCIe-compatible devices 212 and 214.

In this example, a first CCIe-compatible device 212 in the baseband processor 204 may operate as a master device/node and a second CCIe-compatible device 214 in the image sensor 206 may operate as a slave device/node.

While the shared busses (e.g., buses 102 and 208) illustrated in FIGS. 1 and 2 may operate in an I2C mode for I2C-compatible devices and a CCIe mode for CCIe-compatible devices, the disclosure herein is more broadly applicable to other protocols besides I2C and/or CCIe. More generally, one or more aspects provide for a shared multi-mode bus that operates in a first mode of operation (e.g., I2C mode) and a second mode of operation (non-I2C mode).

### Exemplary I2C and CCIe Signaling

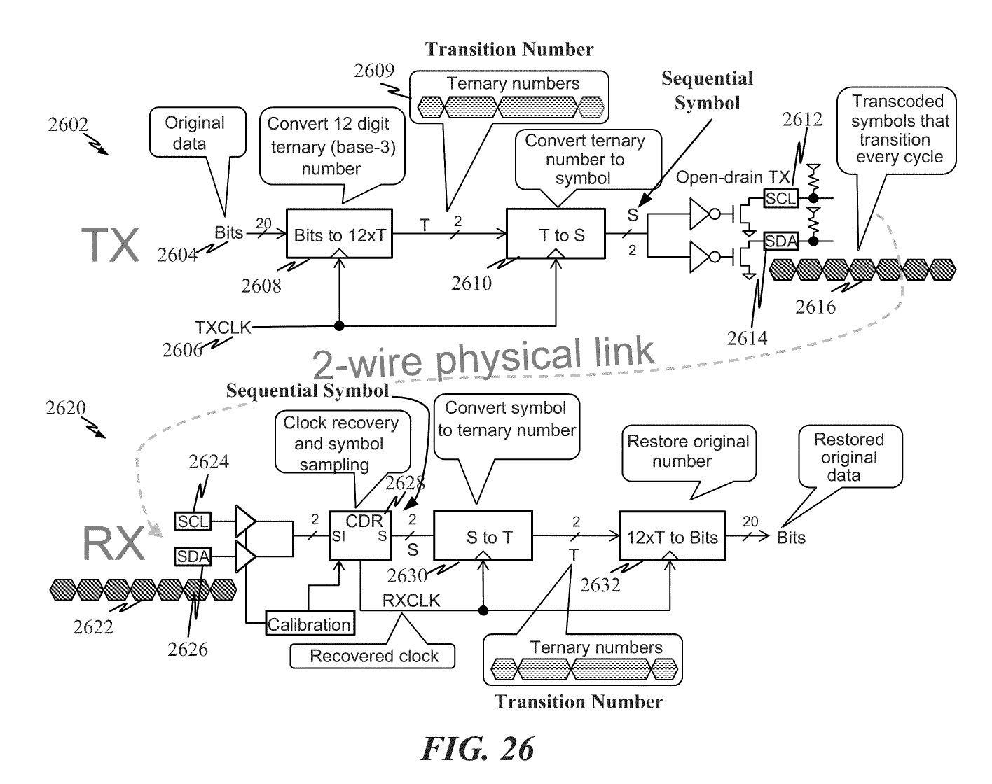

One feature provides for implementing a bus that supports both I2C devices and CCIe devices at the same time. As noted in FIGS. 26-32, it is possible to embed a clock signal (SCL line for I2C bus) within symbol transitions, thereby allowing the use of a clock line (SCL line) for data transmissions. This may permit, for example, a CCIe mode of operation with higher bit rates than typical I2C buses. More generally, the shared bus may support a first mode of operation and a second mode of operations, in which the effective data throughput is greater in the second mode of operation than in the first mode.

However, one challenge is to permit the operation of both legacy I2C devices and CCIe-compatible devices on the same bus. For instance, the I2C devices may remain active (e.g., not disabled or sleeping) while the shared bus operates in the second mode, but signals according to the second mode should not negatively impact the internal states (e.g., sequential combinational logic states) of the I2C devices.

The I2C standard requires that all I2C compatible slave nodes must reset their bus logic on receipt of a START condition (e.g., indicated by a high-to-low transition on the SDA line while the SCL line is high). That is, the I2C devices' logic and/or states are reset as a result of receipt of such START condition.

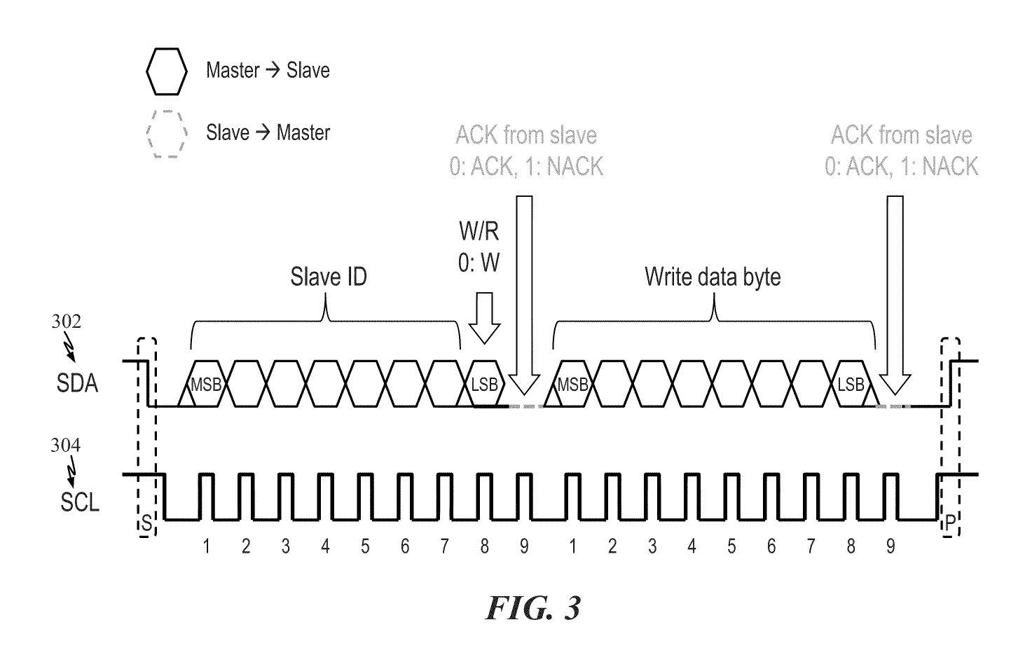

FIG. 3 illustrates a timing diagram of an I2C one byte write data operation. The I2C master node sends a 7-bit slave ID in the SDA line 302 to indicate which slave node on the I2C bus the master node wishes to access, then one bit to indicate a write operation. Only the slave node whose ID matches with the 7-bit slave ID can cause intended actions. In order for an I2C slave node to detect its own ID, the master node has to send at least 8-bits on the SDA line (or 8 clock pulse on the SCL line 304). Therefore, this can be exploited when operating in CCIe mode to prevent legacy I2C slave nodes from reacting to any CCIe operations.

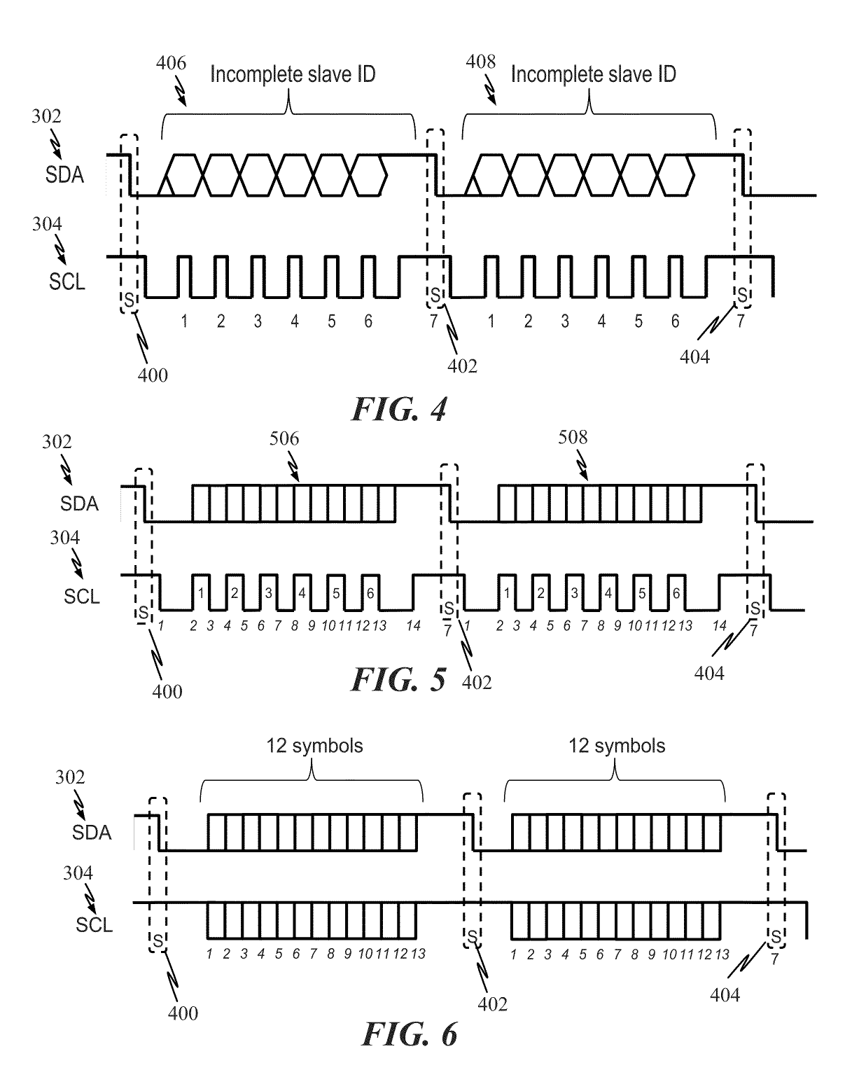

FIG. 4 illustrates the effect a START condition has on a legacy I2C slave node. In this example, the START condition 400, 402, and 404 (i.e., indicated by a high to low transition on the SDA line 402 while the SCL line is high) is detected before a full slave ID (i.e., a full 7 bits) is transmitted, therefore this is an incomplete slave ID (less than 7 bits). If a master node sends 6 SCL pulses then issues a START condition 400, 402, or 404, then all legacy I2C slave nodes reset their bus logic before they are able to recognize the data as an I2C Slave ID. Since the 6-bit sequences 406 and 408 are sent between two START conditions 400, 402, and 404, these bit sequences are not decoded as a valid slave ID by any slave nodes. Consequently, legacy I2C slave nodes will not act upon the incomplete Slave IDs 406 or 408.

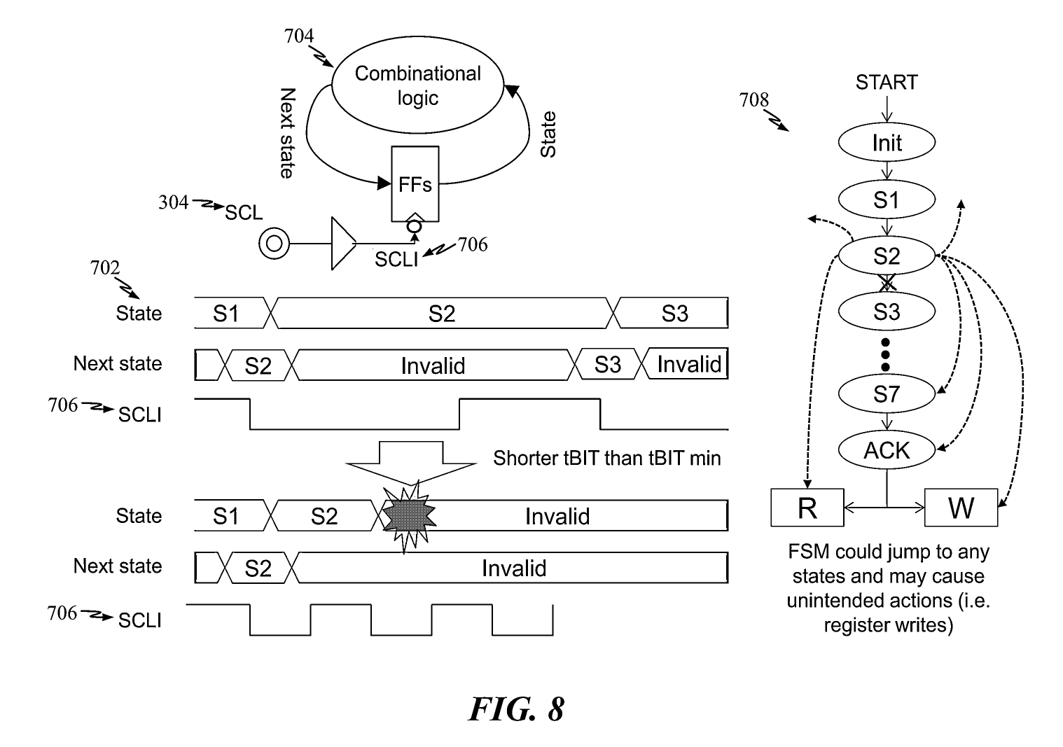

FIG. 5 illustrates the number of clock toggles may be transmitted between two START conditions, and thereby the number of symbols that may be transmitted. As noted in FIG. 8, any SDA states 506 and 508 during a 6-SCL pulse sequence will not cause any slave nodes to detect the sequence as an I2C slave ID because a START condition 400, 402, 404 is transmitted prior to the seventh SCL pulse.

As illustrated in the SDA states 506 and 508 in FIG. 5, even if a SDA transition coincides with a SCL transition or a SDA transition is detected when SCL is high state, this is inconsequential to the legacy I2C slave nodes since the I2C slave nodes reset their bus logic detection upon detection of the START condition 400, 402, and 404. Note that I2C slave nodes may detect some SDA transitions (within the SDA states 506 and 508) as either a START condition or a STOP condition during a sequence. Detection of such STOP condition within the SDA states 506 and/or 508 merely causes the incomplete SID to end earlier. Similarly, detection of such START condition within the SDA states 506 and/or 508 merely resets the I2C function (bus logic reset) of the slave nodes.

Therefore, it is apparent that the legacy I2C slave nodes will not recognize any of the SDA states or symbols 506 or 508 during a 6-SCL pulse sequence as an I2C slave ID. Additionally, during the 14 SCL toggles between START conditions 400, 402, and 404, twelve (12) symbols may be transmitted on the SDA line 302.

FIG. 6 illustrates how both wires/lines of an I2C bus may be utilized for data transmission in CCIe mode. That is, the clock signal has been embedded within symbol transitions. Consequently, the SDA line 302 and SCL line 304 in FIG. 6 can each transmit any arbitrary 12 symbols between two consecutive START conditions without affecting any legacy I2C slave node functionality and without having a bridge device to segregate all legacy I2C slave nodes from the CCIe-capable nodes.

Note that in I2C mode, a START condition is sent only by an I2C master. By contrast, in CCIe mode, a START condition is sent by whichever node is going to send a 12-symbol word.

Additionally, in one example, I2C devices remain coupled o the shared bus and operational while the bus operates in CCIe mode. That is, the I2C devices may not be electrically disconnected or disabled when the bus operates in CCIe mode. Instead, the I2C devices are able to detect transmissions on the shared bus even when the bus operates in CCIe mode.

Under certain conditions, I2C devices may confuse or misinterpret certain CCIe symbol sequences as a valid I2C pulse, thereby causing unwanted and unpredictable changes to the I2C device state machine. For instance, the 12 CCIe symbols sent at a symbol period shorter than half of maximum tBIT period allowed by the I2C specification may cause an I2C device state machine to go into unknown state due to setup timing errors. Slowing down CCIe symbol rate to satisfy a minimum SCL period more than min tBIT requirement slows down the CCIe bit rate from 14 Mbps to 2.4 Mbps which is not acceptable. Consequently, a solution is needed that permits operation of CCIe devices over the bus without causing conflicts or unwanted state changes on the I2C devices.

Note that while CCIe signaling has been used as an example of a protocol that may coexist with I2C devices over a shared multi-mode bus, any other protocol and/or signaling capable of coexisting with I2C devices (or other types of devices) is contemplated herein. However, whatever signaling protocol is used over the shared multi-mode bus should permit the operation of I2C devices. For instance, if the shared multi-mode bus operates according to an I2C-compatible standard in a first mode and according to a second protocol in a second mode of operation, then the second protocol standard should permit operation of I2C-compatible devices. The second protocol should, for example, avoid inadvertently changing the receiver state of the I2C-compatible device while in the bus is in the second mode of operation.

### Problem With I2C Device States

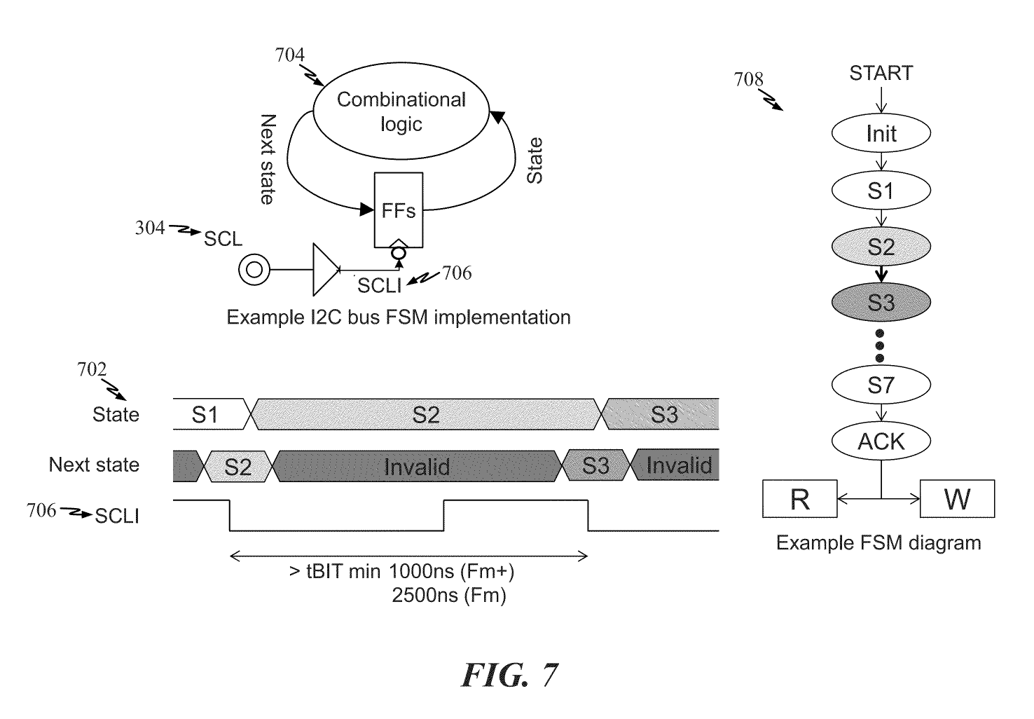

FIG. 7 illustrates a state machine 702 for an I2C device. In the I2C protocol, the state machine 702 is maintained to track symbol transmission and/or reception. The state machine 702 is triggered based on the clock line SCL 304 of the bus. A state machine transitions diagram 708 illustrates possible transmissions for the state machine 702.

FIG. 8 illustrates how as the symbol transmission period on the clock line SCL 304 of the bus gets shorter, the state machine transitions 708 may unpredictably change. As a result of this unpredictable changes, the I2C device may start receiving or transmitting over the bus when it is not supposed to do so. For instance, changes on the clock line SCL 304 when the bus operates in CCIe mode may be incorrectly interpreted by I2C devices as a clock transition (in I2C mode).

One cause of this problem is that the state machine flip flops in I2C devices samples in the output of the combinational logic before the combinational logic is able to output final intended results. In particular, sequential logic changes to unintended states because the combinational logic cannot catch up with the smallest SCL pulse periods (e.g., 2 CCIe symbol periods). In other words, the period of symbol transmissions on the SCL line is shorter than a maximum allowable setup time of the state machine logic. Consequently, pulses in CCIe transmissions that are too short may cause unintended changes in the combinational logic state of I2C devices.

### Exemplary Symbol Stretching to Prevent I2C Device State Machine Changes

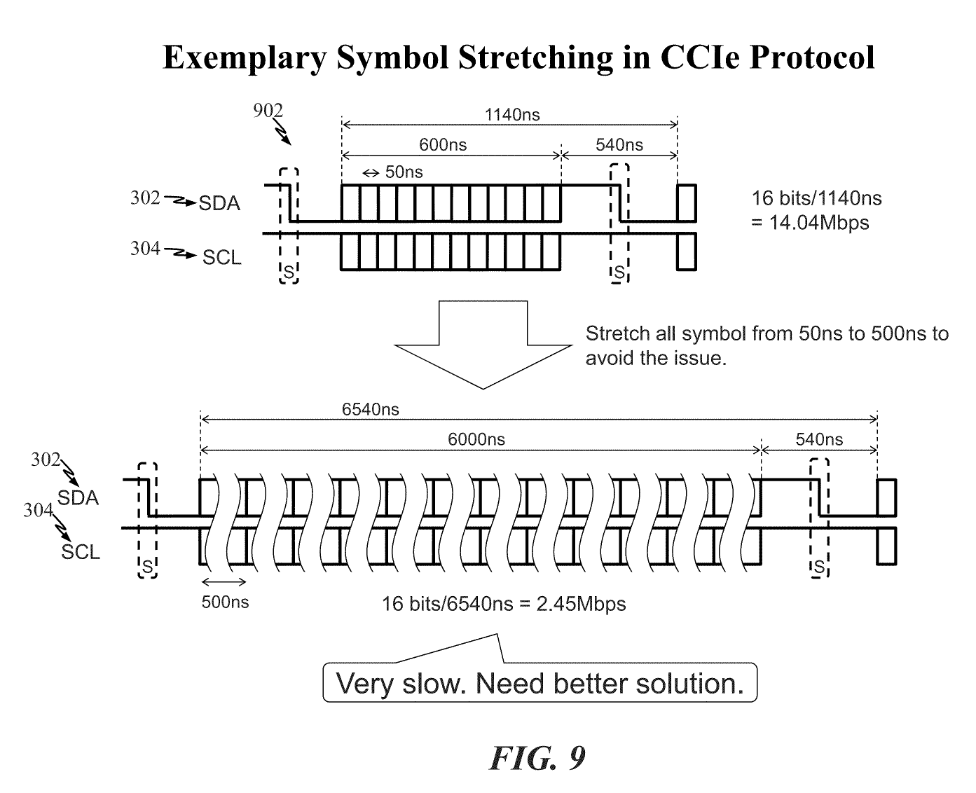

FIG. 9 illustrates one possible solution to preventing an I2C device state machine from changing during CCIe transmission on the shared bus. In this approach, all CCIe symbol transmissions 902 (from FIG. 6) are stretched from 50 nanoseconds (ns) to 500 ns. With 500 ns symbol cycle, the shortest possible SCL period is 1000 ns (1 MHz) which meets Fm+fSCL max requirement. I2C devices may be designed to support Fm+, so it will not have the setup timing issues with this rate and should be able to avoid unintended state changes of its combinational logic. However, stretching the symbol period from 50 ns to 500 ns has the undesirable effect of reducing throughput in CCIe mode from 14.04 Mbps to 2.45 Mbps since each symbol period is longer.

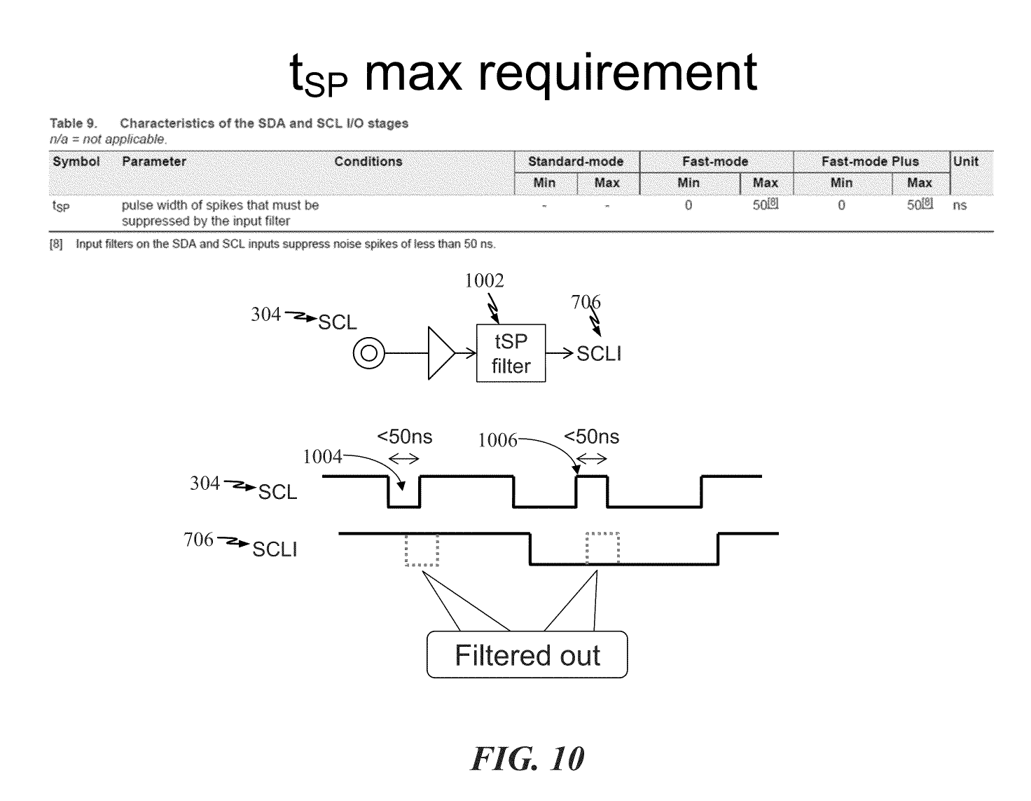

FIG. 10 illustrates that symbol pulse periods less than 50 ns are filtered by input filters (e.g., of a receiver logic/circuit) on the SDA line and/or SCL line of I2C devices. Filtering pulses/spikes of 50 ns or less is a requirement of the I2C specification (e.g., followed by I2C-compatible or compliant devices) and may be used to selectively stretch only symbol transmissions that cause an effective period greater than or equal to 50 ns. This example illustrates a pulse/spike input filter 1002 that filters the pulses on a bus input line SCL that are less than a pre-determined threshold period (e.g., 50 ns or less) to provide filtered signals on the output line SCLI 706. As illustrated in FIG. 10, pulses 1004 and 1006 of less than 50 ns on the input line SCL 304 are filtered out on the output line SCLI 706. Such filter 1002 may be implemented, for example, at the input interface to the shared bus (e.g., on the interface coupling to the SCL line).

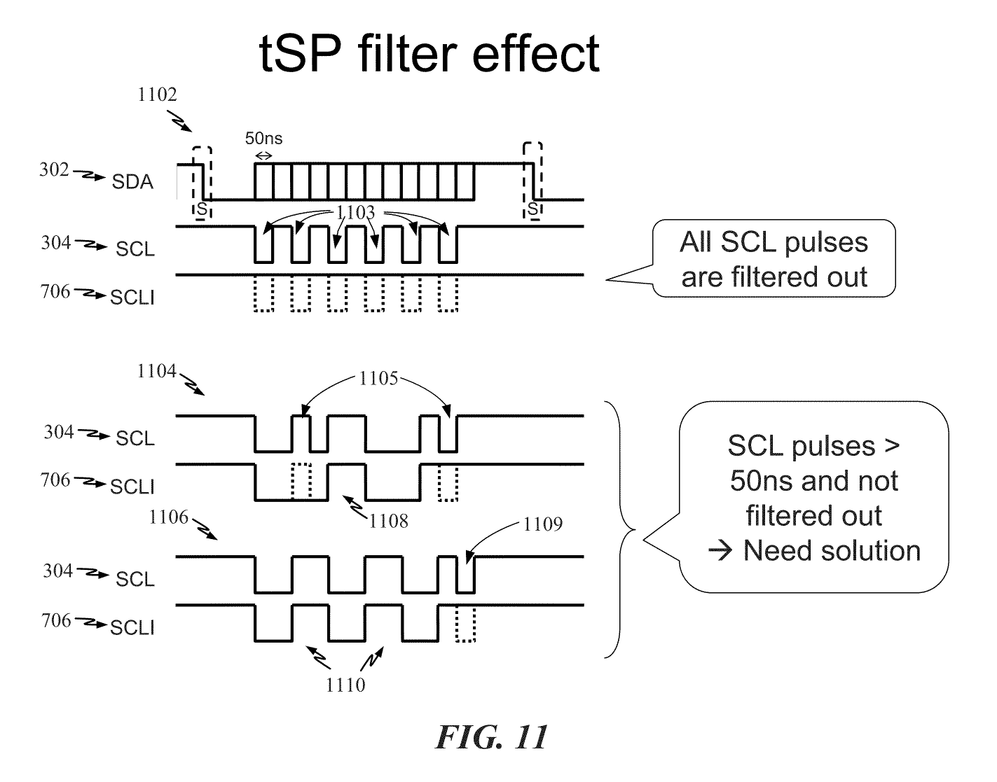

FIG. 11 illustrates how some pulses may be filtered by the input filters of an I2C device receiver. In the first graph 1102, the SDL line 302 and SCL line 304 have pulses of 50 ns or less. That is, in this example, the pulses on the SCL line 304 switch state (e.g., low-high or high-low) every period. The pulses 1103 on the SCL line 304 are filtered out by the input filter of the I2C device receiver so that the SCLI line 706 has no transitions (i.e., no clock signal reaches the combinational logic 704).

In the second graph 1104, some pulses 1105 on the SCL line are 50 ns or less and are filtered out by the input filter. However, other pulses 1108 on the SCL line 304 do not change state every period, so some appear as pulses 1108 having a period greater than 50 ns. Consequently, these pulses 1108 on the SCLI line 706 may not be filtered out by the input filter of the I2C device receiver. These pulses 1108 then reach the combinational logic and may cause unwanted state changes.

In the third graph 1106, some pulses 1109 having a period of 50 ns or less on the SCL line 304 are filtered by the input filter of an I2C device but many more other pulses 1110 may reach the SCLI line 706, and may cause unwanted state changes to the I2C devices.

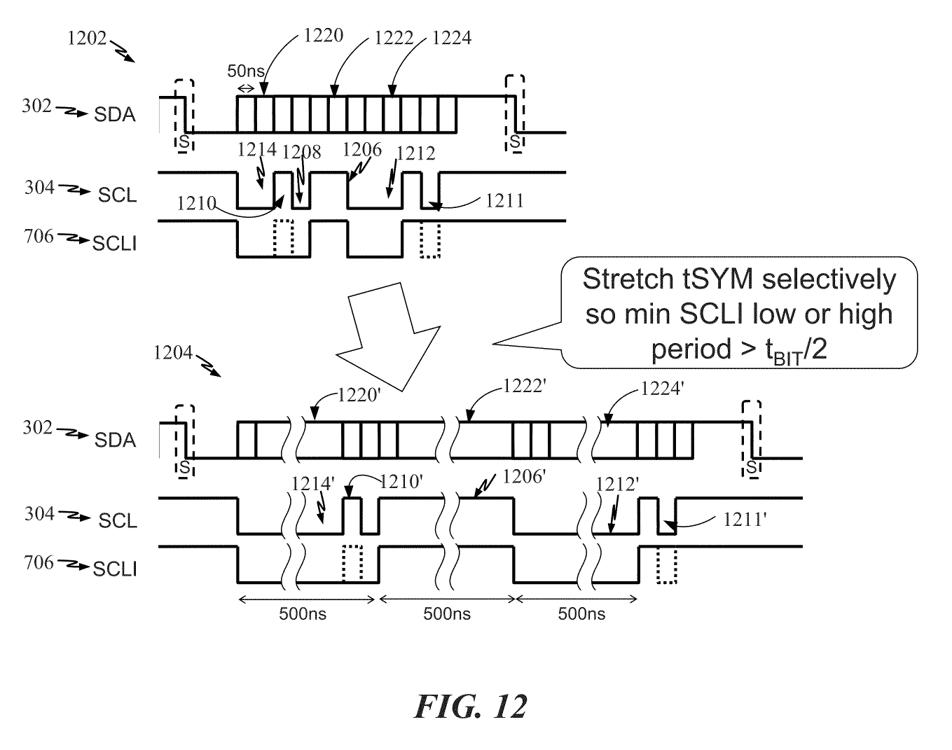

FIG. 12 illustrates how, in CCIe mode, some symbol pulses on the SCL line may be selectively stretched so that unwanted state changes do not occur on the I2C device. A first graph 1202 illustrates some pulses that may be filtered by the input filter of the I2C receiver device while some symbol slots may require stretching. For example, a first pulse 1210 and a second pulse 1211, each within a single symbol slot, may be filtered by an input filter that filters out pulses of 50 ns or less (see SLCI line 706). Additionally, some symbols slots on the clock line SCL (for I2C devices) may be stretched to avoid I2C devices from interpreting transitions as a clock signal when the bus is operating in CCIe mode. In various examples the terms “symbol slot stretching” or “symbol stretching” may be interchangeably used herein to refer to the stretching or expanding the duration or period of a pulse or symbol within a transmission slot (i.e., effectively also stretching the transmission slot).

A first symbol slot 1220, (having a third pulse 1214), a second symbol slot 1222 (having a fourth pulse 1206), and a third symbol slot 1224 (having a fifth pulse 1212) may be stretched. For instance, since a low-to-high transition occurs between the third pulse 1214 and the next symbol slot, this is a condition which may cause unwanted state changes in I2C devices. Consequently, the corresponding symbol slot 1220 needs to be stretched. Similar conditions are present after the fourth symbol 1206 and fifth symbol 1212.

In a second graph 1204, some symbol slots 1220′, 1222′ and 1224′ (carrying pulses 1214′, 1206′ and 1212′) are stretched so that the period between state changes is at least 500 ns (i.e., each symbol slot is at least 500 ns), thereby preventing changes to the I2C device states. That is, these symbol slots 1220′, 1222′ and 1224′ are stretched sufficiently to satisfy a minimum required SCL low or high time for I2C devices. Short pulses 1210′ and 1211′ (e.g., 50 ns or less) are still filtered by the input filter.

Note that, in order to perform such symbol slot stretching, the transmitting CCIe device may look ahead to (at least) the next symbol to ascertain whether a change of state is occurring. If so, the transmitting CCIe device may ascertain whether a symbol slot (e.g., a transmitted symbol therein) should be stretched to permit coexistence with I2C devices on a shared multi-mode bus.

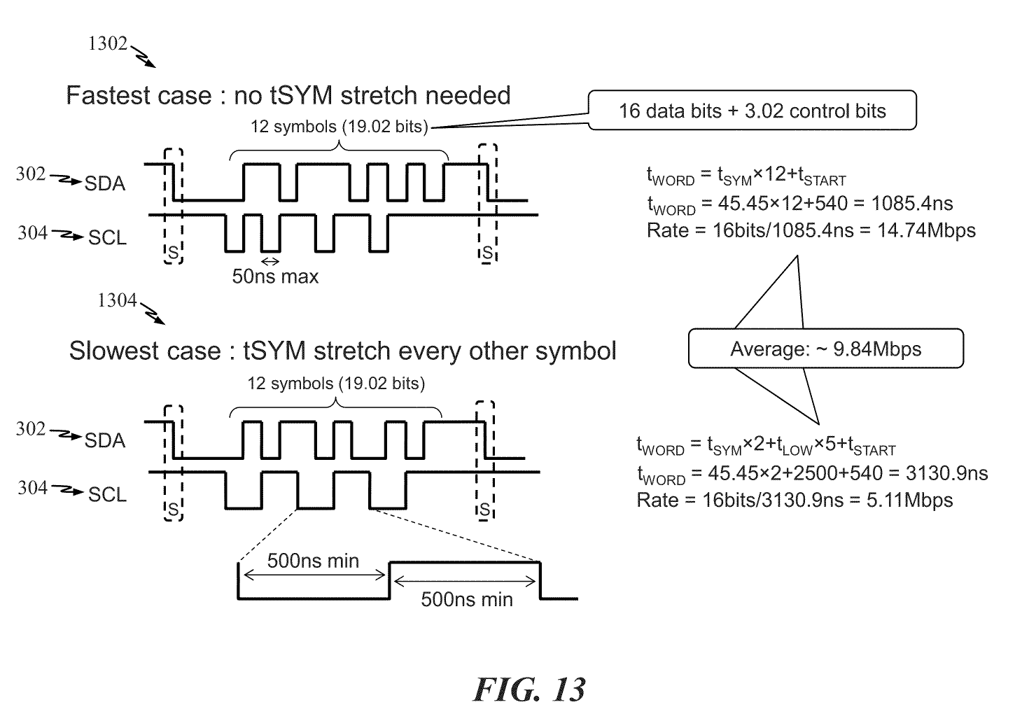

FIG. 13 illustrates a best case scenario 1302 and a worst case scenario 1304 of data throughput for the approach in which certain symbol periods/slots are selectively stretched. In the best case scenario 1302 no symbols are stretched during CCIe mode, so pulses can be transmitted at 50 ns or less, resulting in an effective rate of approximately 14.74 Mbps. In the worst case scenario 1304, every symbol is stretched during CCIe mode, so pulses can be transmitted at 500 ns or more, resulting in an effective rate of approximately 5.11 Mbps.

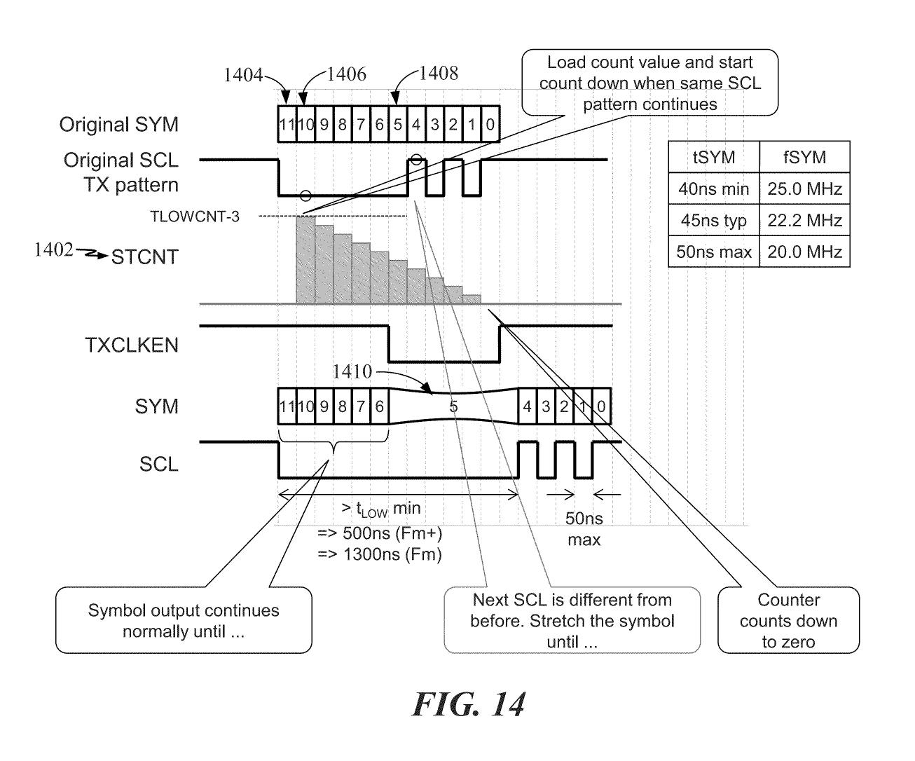

FIG. 14 illustrates a technique for a CCIe transmitter to track when a symbol (in low state) should be stretched to facilitate coexistence with I2C devices on a shared multi-mode bus. In this approach, the symbol period of some or all of the symbols in CCIe transmissions may be stretched so that, transitions occur at periods of 500 ns or greater as perceived by I2C devices. In particular, when two or more sequential symbols transmitted over the shared bus in CCIe mode have the same state (e.g., low or high), no transition is perceived by I2C devices. Consequently, rather than stretching every symbol transmitted in CCIe mode on the SCL line to avoid I2C devices from perceiving/detecting a clock transition, the transmitting CCIe devices may recognize when sequential symbols have the same state and then intelligently stretch the last symbol in that sequence of symbols.

For example, if a plurality of sequential symbols on the bus operating in CCIe mode have the same state (e.g., either low or high), then a counter may be started to ascertain how long the state on the SCL line has remained unchanged and how long a final symbol in that sequence of symbols may need to be stretched to accommodate I2C devices. When two or more symbols have the same pattern (e.g., high or low state), a countdown value (STCNT) 1402 is started to ascertain by how much a particular symbol should be stretched. The countdown value may be decreased every symbol cycle/slot by 50 ns until it reaches zero. When the countdown value 1402 reaches zero, this means that the perceived pulse (at the I2C receiver) is at least 500 ns long and will not be perceived as a clock transition on the SCL line. This satisfies legacy I2C SCL minimum low or high period requirements. In this example, a first symbol 11 1404 and a second symbol 10 1406 are sequential symbols of the same pattern or state. So, the countdown counter STCNT 1402 is started on the second symbol 10 1406. The counter continues to count down until there is a state change between consecutive symbols or it reaches zero. In this example, symbols 11 to 5 are all the same (i.e., low), but symbol 4 is different (high). So, symbol 5 (in a low state) is stretched so that the perceived pulse (i.e., from the first pulse 11 1404 to the end of the pulse 5 1408) at the I2C device is equal to or greater than 500 ns.

Note that, in this example, since symbol 11 1404 to symbol 5 1408 are all the same state (i.e., low), the last symbol 5 1408 need only be stretched enough so that the total perceived period from symbol 11 1404 to symbol 5 1408 is at least 500 ns long (i.e., the symbol 5 1408 is individually stretched less than 500 ns). For instance, in this example the stretched symbol 5 1410 may be approximately 250 ns long since the symbols 11 to 6 are each approximately 50 ns long.

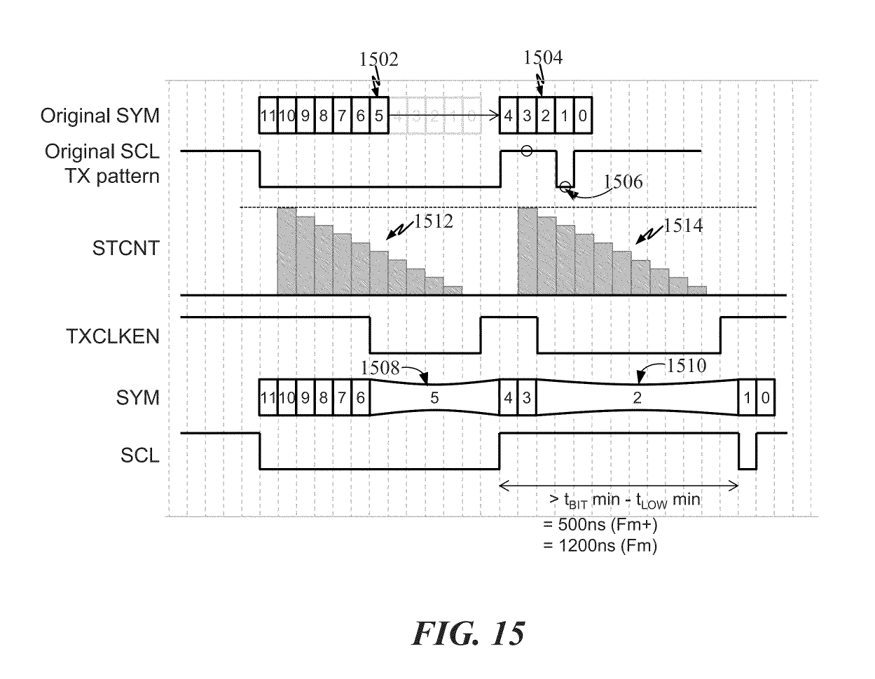

FIG. 15 illustrates another example in which symbol slots are selectively stretched during a transmission by the transmitting CCIe device to facilitate coexistence with I2C devices on a shared multi-mode bus. In this example, a first symbol 1508 at a first symbol slot 5 1502 (in a low state) is stretched (using a first countdown counter 1512) and a second symbol 1510 at a second symbol slot 2 1504 (in a high state) is stretched (using a second countdown counter 1514). In this example, the second symbol slot 2 1504 is blindly stretched since there are at least two consecutive symbols (i.e., in symbol slots 4 and 3) in the SCL line, without consideration as to the length of the subsequent pulse 1506.

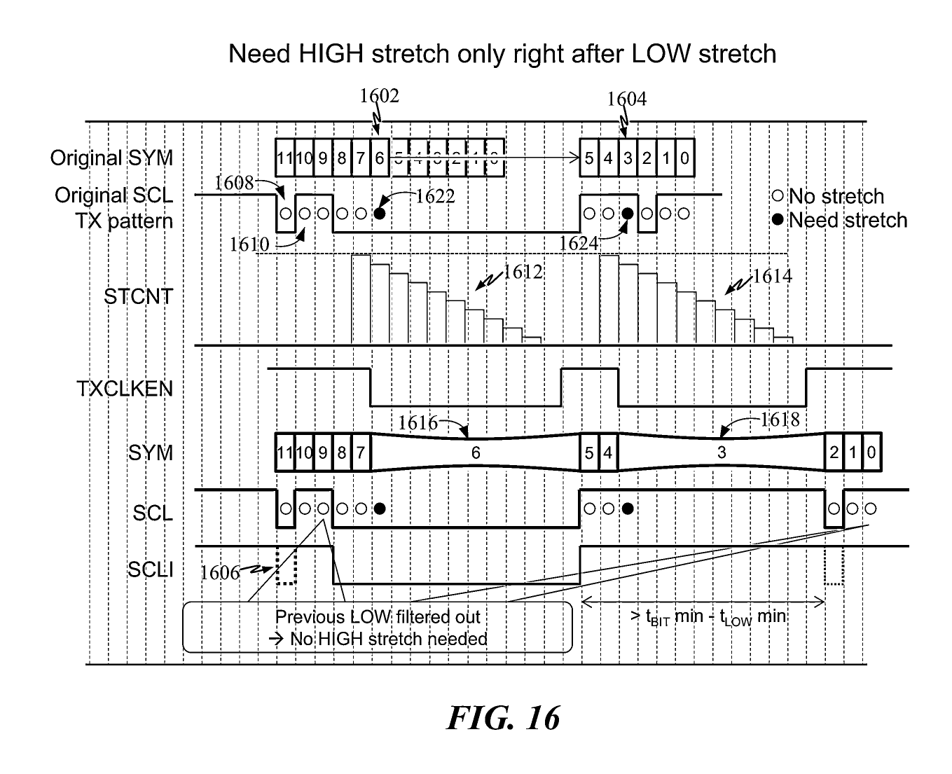

FIG. 16 illustrates yet another example in which two symbol slots are stretched during a transmission by the transmitting CCIe device to facilitate coexistence with I2C devices on a shared multi-mode bus. In this example, a first symbol 1622 at a first symbol slot 6 1602 (in a low state) is stretched (using a first countdown counter 1612) and a second symbol 1624 at a second symbol slot 3 1604 (in a high state) is stretched (using a second countdown counter 1614). That is, the first symbol 1622 is stretched to obtain a first stretched symbol 1616 and the second symbol 1624 is stretched to obtain a second stretched symbol 1618. This example also illustrates that even though there is a symbol transition from a symbol 11 to a symbol 10, there is no need to stretch symbol 11 since it is filtered out 1606 by input filters of I2C devices. However, the high to low transition from symbol slot 9 to symbol slot 8 may be perceived as a clock pulse by the I2C receiver. Consequently, since there is a low to high transition from symbol 6 to symbol 5, this requires that symbol slot 6 1602 be stretched until the countdown value (STCNT) 1612 reaches zero (e.g., until the perceived pulse period is at least 500 ns).

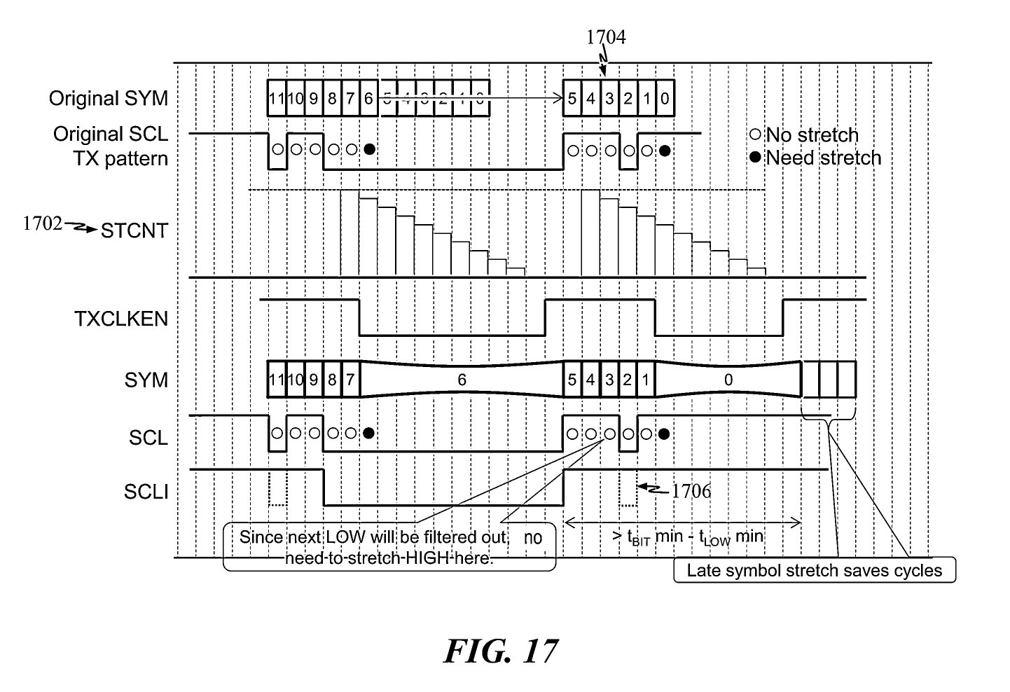

FIG. 17 illustrates yet another example in which two symbols slots are stretched during a transmission by a transmitting CCIe device to facilitate coexistence with I2C devices on a shared multi-mode bus. This example is similar to that of FIG. 16 but the transmitting CCIe device looks ahead in the transmission pattern and decides how long it needs to stretch a symbol having a HIGH period based on future symbol transmissions (i.e., on subsequent symbol slots). If there is no non-filtered symbols with a LOW period in the future, one HIGH period stretch can continue for as many symbols as it can to minimize word time.

In this example, there is no need to stretch symbol slot 3 1704 since symbol 2 will be filtered out 1706 by the input filter of I2C devices since the pulse period is 50 ns or less. Instead, to guarantee the perceived pulse period from symbol 5 to symbol 0 is at least 500 ns long, the symbol slot 0 is stretched. Because the transition from symbol 3 to symbol 2 is ignored (because the transmitter knows that the single symbol 2 will be filtered), symbol stretching can be delayed until symbol 0, thereby saving three pulse periods.

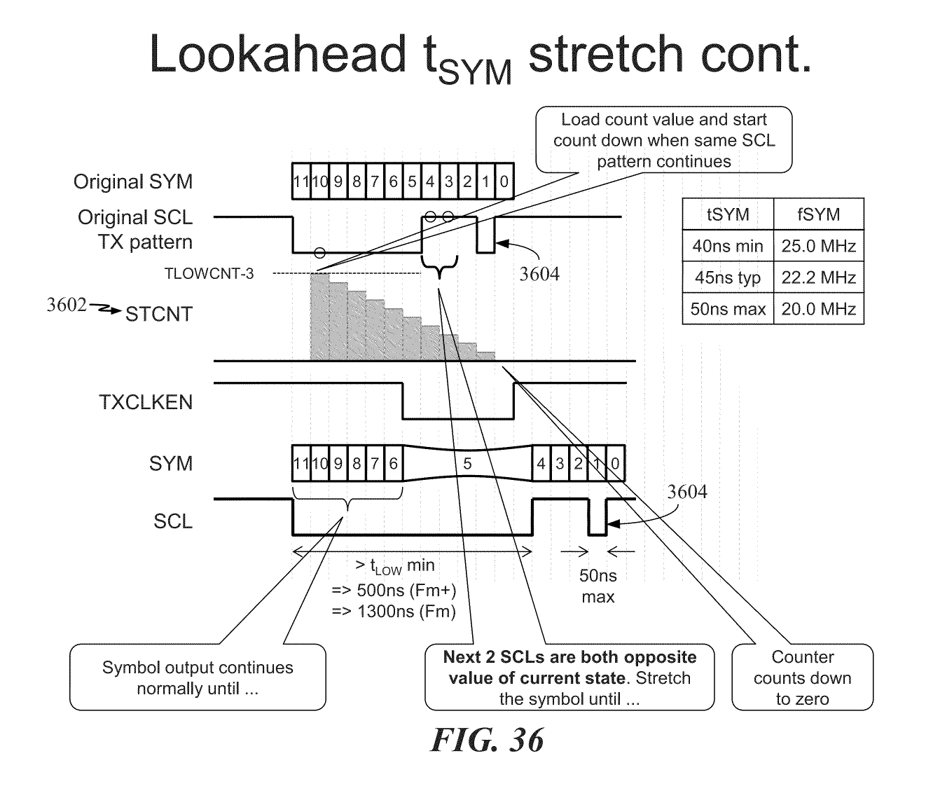

FIG. 36 illustrates yet another example in which a symbol slot is stretched during a transmission by a transmitting CCIe device to facilitate coexistence with I2C devices on a shared multi-mode bus. When two or more symbols (e.g., symbols 11 and 10) have the same pattern (e.g., high or low), a countdown counter (STCNT) 3602 is started to ascertain by how much a particular symbol should be stretched. The countdown value may be decreased every symbol cycle by 50 ns until it reaches zero. When it reaches zero, this means that the perceived pulse (at the I2C receiver) is at least 500 ns long. In this example, symbols 11 to 5 are all the same (i.e., low), but symbol 4 is different (high). So, symbol 5 (in a low state) is stretched so that the perceived pulse at the I2C device is equal to or greater than 500 ns.

While similar to the example illustrated in FIG. 15, the example in FIG. 36 has the transmitting CCIe device look ahead in the transmission pattern and decide how long it needs to stretch a LOW period based on future symbol transmissions (i.e., subsequent symbol slots). In this example, symbols 4 and 3 are both opposite the state of symbol 5, which would normally cause a new countdown counter to start. However, because the CCIe transmitter looks ahead, it knows that a transition will occur between symbol 2 and symbol 1 but another transition occurs from symbol 1 to symbol 0. Consequently, the period of symbol 1 is 50 ns or less and symbol 1 3604 will be filtered out by the input filter of I2C devices.

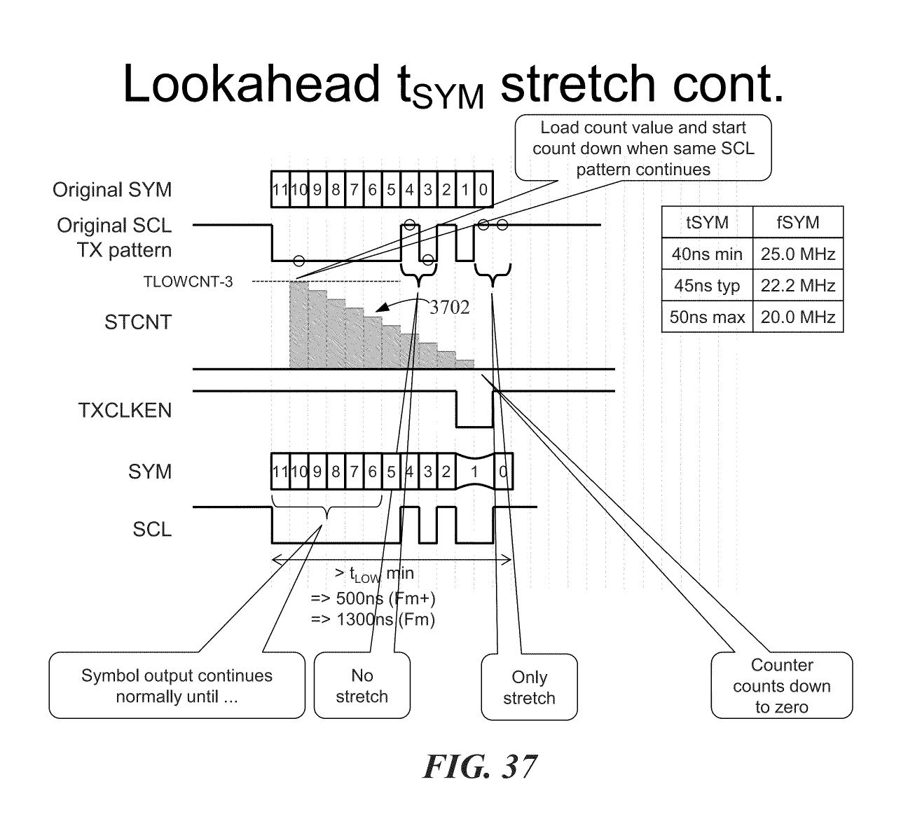

FIG. 37 illustrates yet another example in which a symbol slot is stretched during a transmission by a transmitting CCIe device. Here, a symbols 11 and 10 have the same state and a countdown counter is started 3702 is started. A transition occurs from symbol 5 to symbol 4, which would normally cause symbol 5 to be stretched. However, the transmitting CCIe device looks ahead and notices that a transition also occurs from symbol 4 to symbol 3. Consequently, the transmitting CCIe device knows that symbol 4 has a period that is only 50 ns or less and will be filtered out the input filters of I2C devices. Thus, symbol 4 can be ignored and there is no need to stretch symbol 5.

Similarly, the transmitting CCIe device knows that another transition occurs from symbol 3 to symbol 2, which would normally cause symbol 3 to be stretched. However, the transmitting CCIe device looks ahead and notices that transition also occurs from symbol 2 to symbol 1. Consequently, the transmitting CCIe device knows that symbol 2 has a period that is only 50 ns or less and will be filtered out the input filters of I2C devices. Thus, symbol 2 can be ignored for purposes of symbol stretching and there is no need to stretch symbol 3.

It is only when a transition occurs that continues to two or more symbols that symbol stretching would be implemented. Here, the countdown counter 3702 is still running when a transition from symbol 1 to symbol 0 occurs, and the state of symbol 0 extends to at least the next sequential symbol. Consequently, symbol 1 is stretched 3704 to guarantee that the perceived period from symbol 11 to symbol 0 is at least 500 ns long.

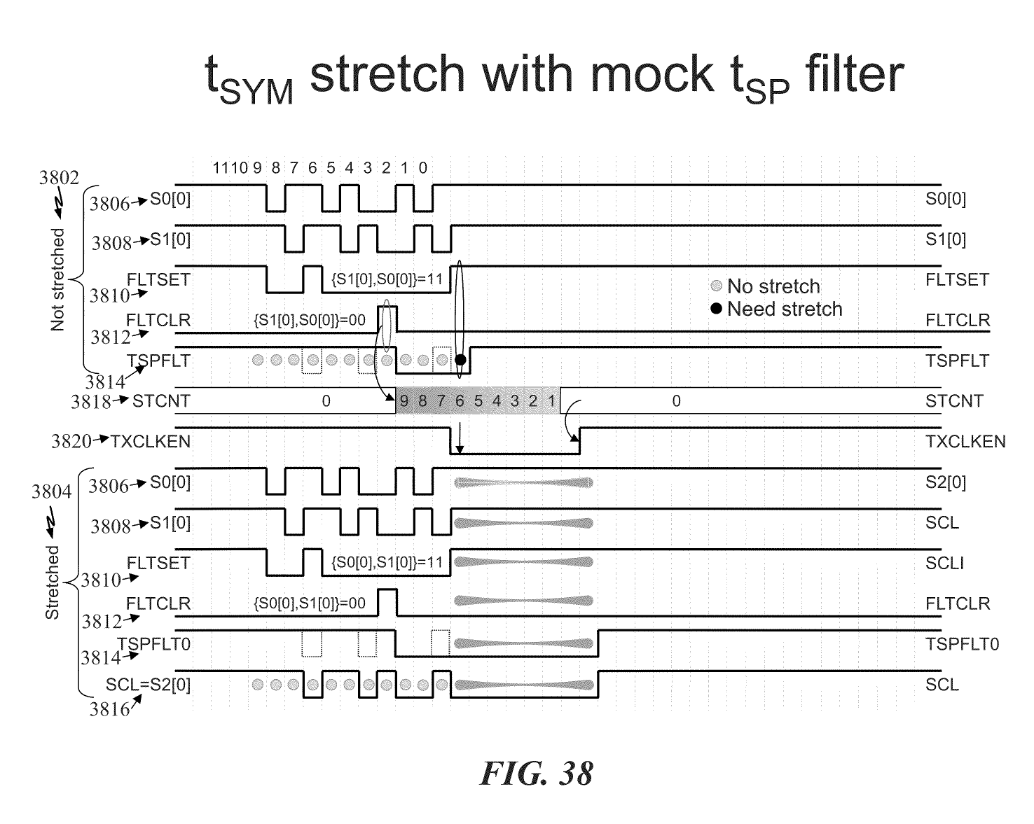

FIG. 38 illustrates another example in which a transmitting CCIe device includes a mock filter similar to those of I2C devices to more efficiently implement symbol stretching. Here, the shared multi-mode bus includes a line S0[0] 3806. A delayed version of the line S0[0] 3806 is shown as S1[0] 3808. A filter set FLTSET line 3810 is set to high (1) when both S1[0] and S0[0] are set high (or 11). A filter clear FLTCLR line 3812 is set to high (1) when both S1[0] and S0[0] are set low (or 00). The TSPFLT signal 3814 is the SCL signal after a mock filter has been applied at the transmitting CCIe device to filter out pulses that are less than a threshold period (e.g., 50 ns or less). Only when the transmitter on the CCIe device perceives a state change between pulses on the TSPFLT signal 3814 does a symbol get stretched. The same symbol stretching technique(s) illustrated in FIGS. 15 and 16 may be applied to the TSPFLT signal 3814 instead of the SCL output signal. In one example, the TSPFLT line 3814 may represent how legacy I2C slave devices would see the SCL input. Therefore, the transmitting CCIe device stretches the pulse width on the TSPFLT line that is shorter than a minimum threshold period (e.g., a minimum low or high period detectable by I2C devices).

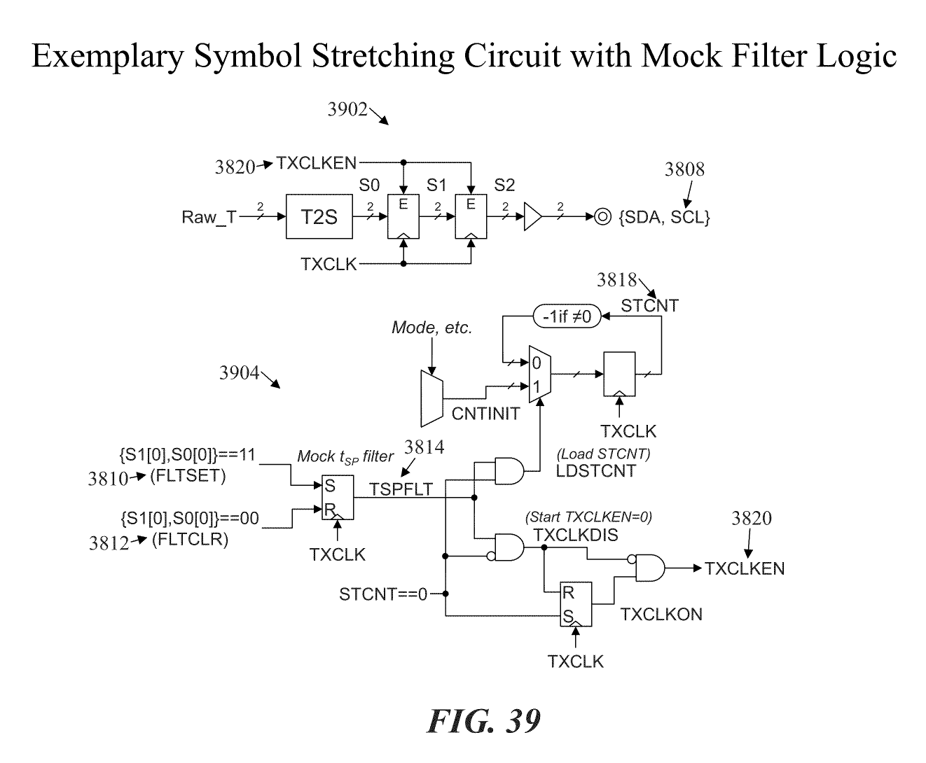

FIG. 39 illustrates an exemplary logic circuit implementing look ahead symbol stretching in a CCIe device to facilitate coexistence with I2C devices on a shared multi-mode bus. A mock filter circuit 3904 may be configured to filter out pulses (e.g., pulses of source states of SCL (S1[0], S0[0])) that are less than a threshold period (e.g., 50 ns or less). The filter circuit 3904 may include a set/reset (SR) latch or flip-flop device that receives filter set signal FLTSET 3810 and filter clear signal FLTCLR 3812 and outputs the TSPFLT signal 3814 while clocked by a transmit clock TXCLK. A transmitter circuit 3902 then transmits symbols over the shared multi-mode bus that includes the SCL line according to the transmit clock enable signal TXCLKEN 3820 generated by the mock filter circuit 3904. A plurality of additional logic gates and multiplexers serve to maintain the symbol stretch countdown counter STCNT 3818 and a transmit clock enable signal TXCLKEN 3820 which is used to trigger the transmission of symbols by the transmitter circuit 3902. Note that, as illustrated in FIGS. 14, 15, 16, 17, 36, 37, and/or 38, the transmit clock enable signal TXCLKEN serves to stretch or extend a symbol period when necessary.

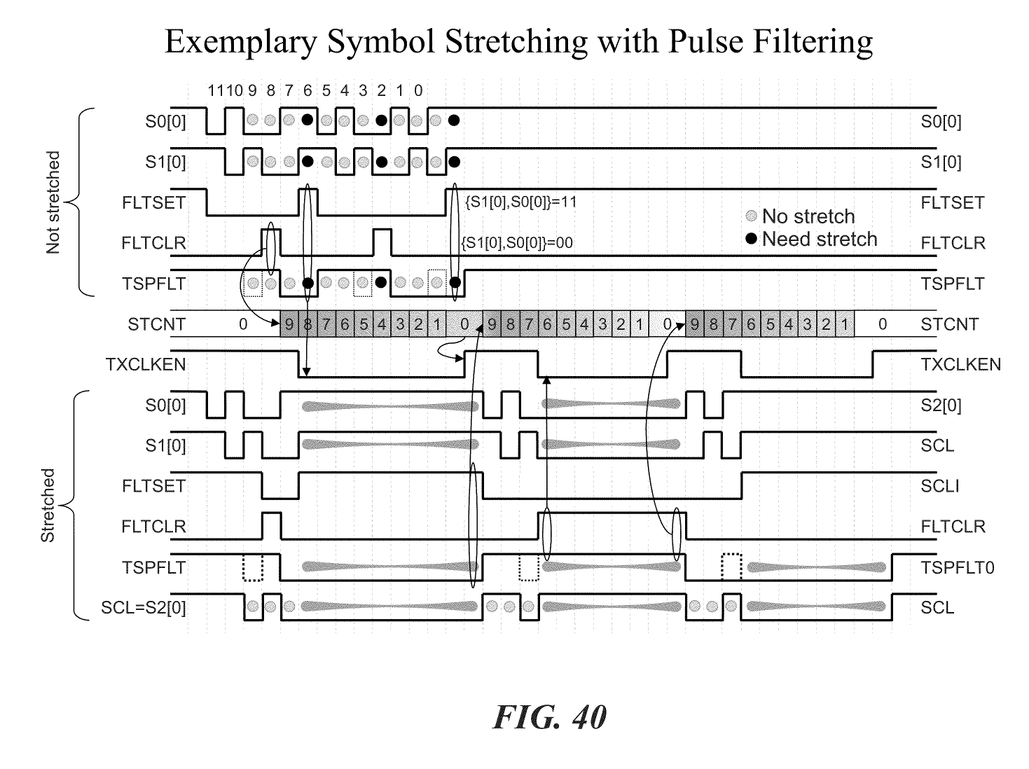

FIG. 40 illustrates another example in which a transmitting CCIe device includes a mock filter similar to those of I2C devices to more efficiently implement symbol stretching. This example is similar to that of FIG. 38 and may be based on the circuits of FIG. 39 so that a transmitting circuit anticipates symbol filtering at receiving I2C devices and intelligently stretch symbols when necessary to avoid causing unintended state changes on the receiving I2C devices. FIG. 40 illustrates how symbol stretching with a mock tSP filter works on symbol sequences more complicated than those in FIG. 38. For instance, FIG. 38 illustrates the case where stretching of a low period is required. Meanwhile, FIG. 40 illustrates not only symbol stretching of low periods (1^{st} and 3^{rd} stretches), but also symbol stretching of high period (the 2^{nd} stretch).

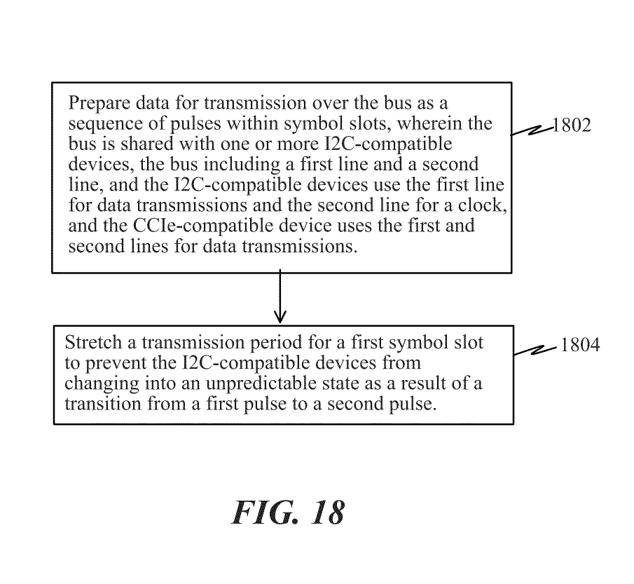

FIG. 18 illustrates a method operational on a CCIe-compatible device. Data is prepared for transmission over the bus as a sequence of pulses within symbol slots, wherein the bus is shared with one or more I2C-compatible devices, the bus including a first line and a second line, and the I2C-compatible devices use the first line for data transmissions and the second line for a clock, and the CCIe-compatible device uses the first and second lines for data transmissions 1802. A transmission period is stretched for a first symbol slot to prevent the I2C-compatible devices from changing into an unpredictable state as a result of a transition from a first pulse to a second pulse 1804. The first symbol slot may correspond to the first pulse. The first symbol slot is stretched so that a perceived period without a state change by the bus at the I2C-compatible devices is at least a first threshold period. The first threshold period corresponds to a minimum period that I2C-compatible devices can reliably detect state changes on the bus.

When two state changes occurring within less than a second threshold period of time are filtered out by I2C-compatible devices and do not necessitate stretching of a symbol slot.

### Unintended Start/Stop Metastability Problem

During the twelve (12) CCIe symbol transmissions, signal metastability may occur in the logic devices of legacy I2C devices coupled to a bus shared with CCIe devices. Such metastability may occur, for example, when the SDA line and SCL line states change at the same time. A legacy I2C device may or may not detect the transition as a START or STOP condition. Such detections may become metastable, which may cause logic devices in legacy I2C devices coupled to the shared bus to go into a wrong/unknown state.

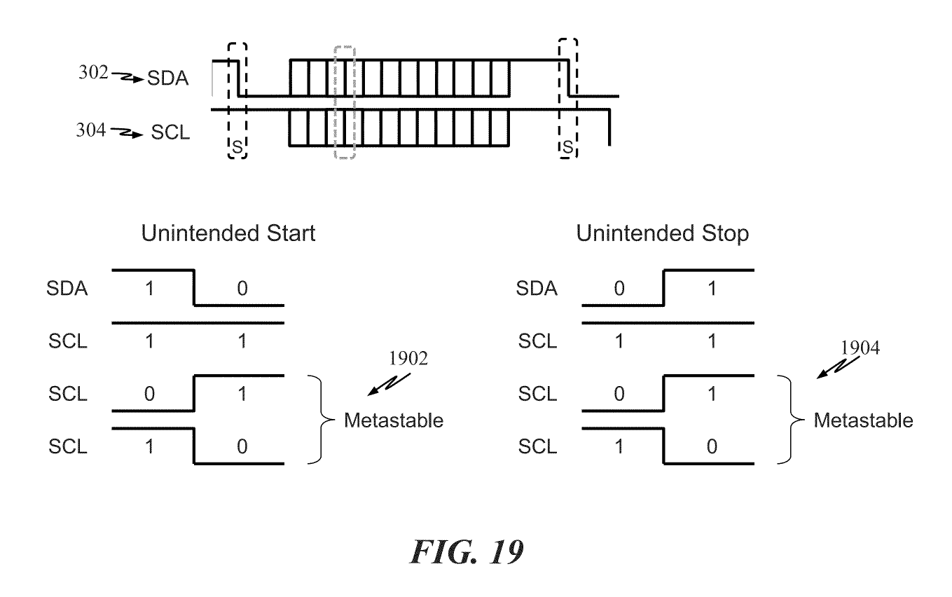

FIG. 19 illustrates the conditions under which a metastable state may occur. That is, when both the data line (SDA) 302 and the clock line (SCL) 304 change at the same time (as in 1902 and 1904), then a metastable condition may occur at I2C devices.

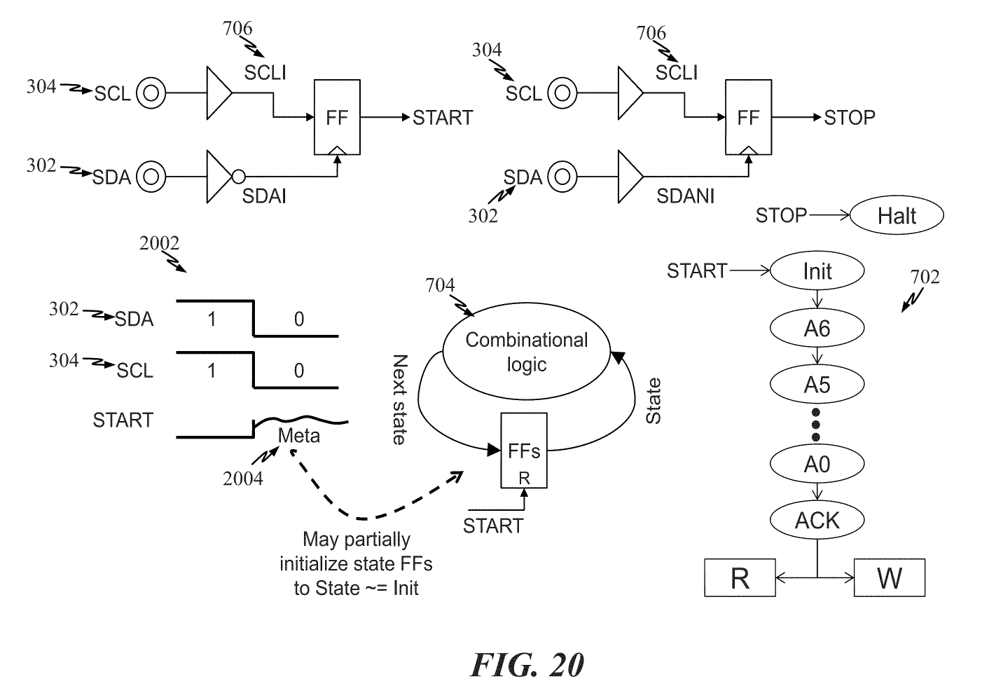

FIG. 20 illustrates the occurrence of a metastable condition 2004 when both the SDA and SCL lines change states at the same time 2002.

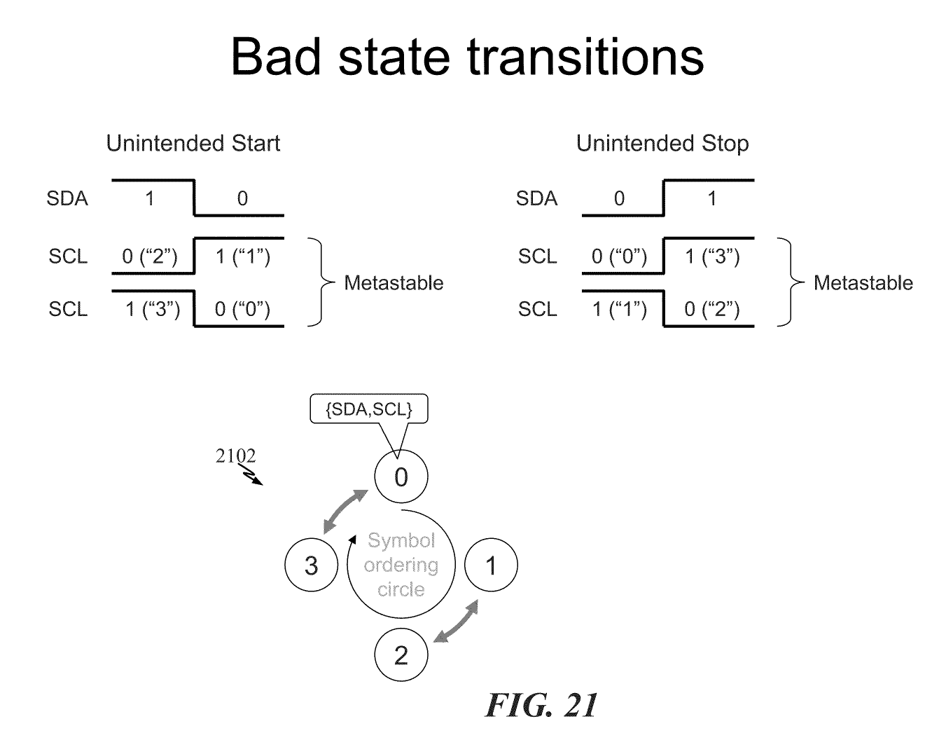

FIG. 21 illustrates the conditions that must be avoided to prevent an unintended START or STOP condition. “Symbols” 2102 may be defined by the combination of states between the SDA line and SCL line. For example, Symbol “0” is when both the SDA line and SCL line are low (0). Symbol “1” is when the SDA line is low (0) and the SCL line is high (1). Symbol “2” is when the SDA line is high (1) and the SCL line is low (0). Symbol “3” is when the SDA line is high (1) and the SCL line is high (1). Here, it can be appreciated that that symbol transitions from symbol “2” to symbol “1” and from symbol “3” to symbol “0” cause a metastable condition for a START indicator. Similarly, symbol transitions from symbol “0” to symbol “3” and from symbol “1” to symbol “2” cause a metastable condition for a STOP indicator.

### Exemplary Solution to Start/Stop Metastability Problem

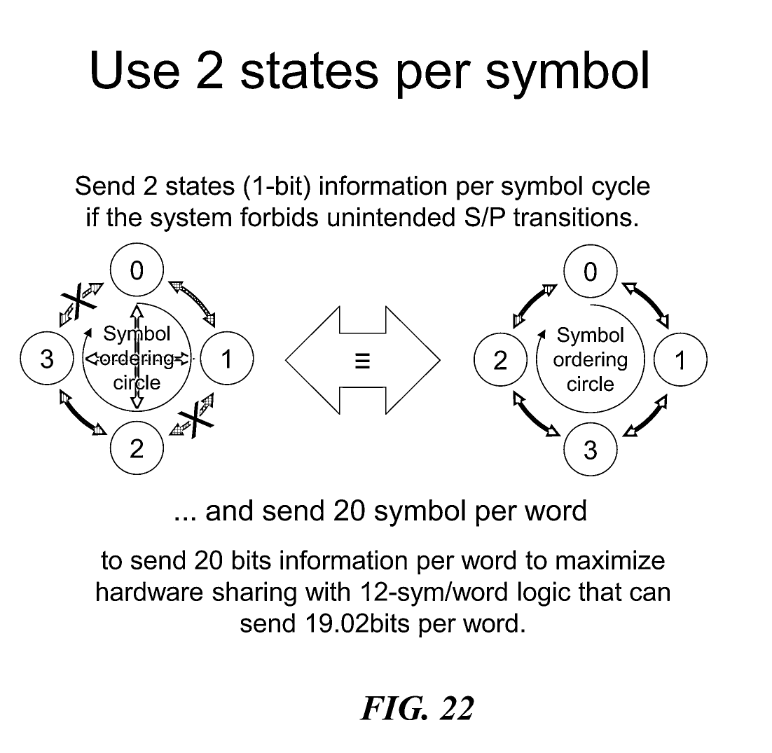

FIG. 22 illustrates that the transitions between symbols that cause metastable conditions may be eliminated, but now 20 bits per word are sent in order to increase the effective data throughput as well as to keep as much compatibility with the original 12 symbol CCIe systems as possible.

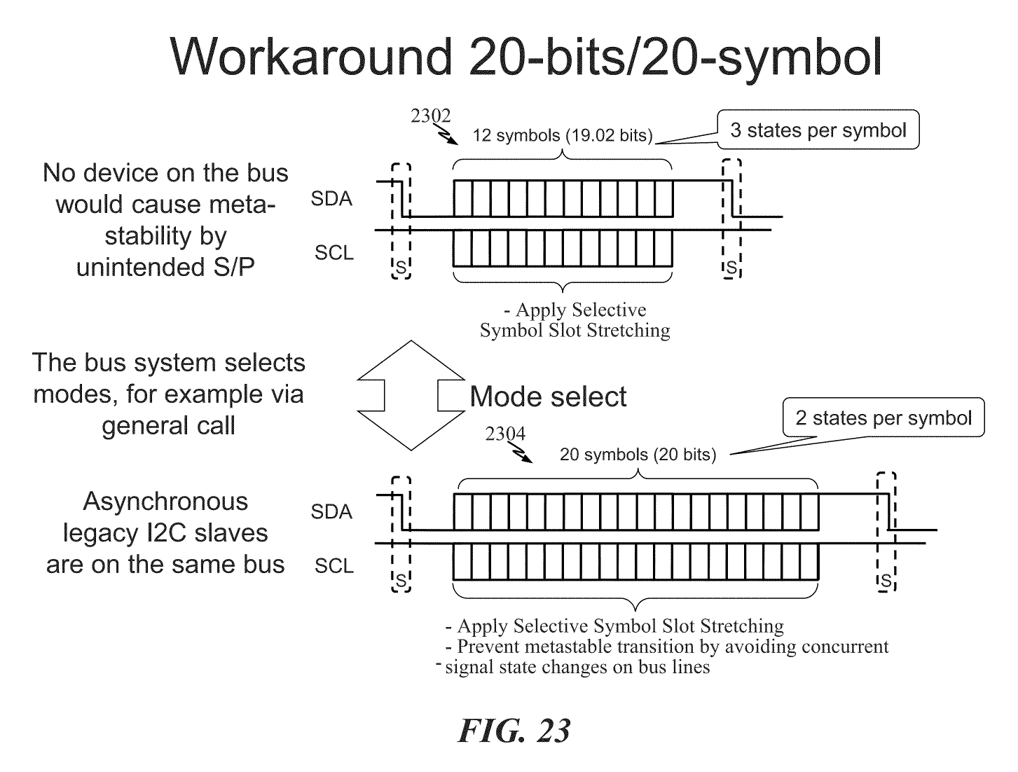

FIG. 23 illustrates a comparison between a first transmission scheme using 12 symbols of 3 states per symbol and a second transmission scheme using 20 symbols of 2 states per symbol. The first transmission scheme can transmit 19.02 bits within 12 symbols while the second transmission scheme can transmit 20 bits within the 20 symbols.

According to one aspect, a master device coupled to a bus may ascertain whether there are any legacy I2C devices coupled to the bus. If no legacy I2C devices are coupled to the bus, then the CCIe devices need not worry about causing metastable conditions and may transmit 12 symbols of 3 states per symbol.

Even if I2C devices are coupled to the bus, the CCIe devices may still transmit 12 symbols of 3 states per symbol, without symbol slot stretching or attempting to avoid a metastable condition, if all legacy I2C devices on the bus are synchronously designed with reasonably fast clock (which avoids the need for selective stretching of symbol slots as the well as the possibility of a metastable condition).

If there are legacy I2C devices coupled to the bus, and all legacy I2C devices on the bus are synchronously designed and free from the possibility of metastability, but some I2C devices are not immune to the state machine changes, then symbol slot stretching may be used. The CCIe devices may still transmit 12 symbols of 3 states per symbol but, due to the stretched symbol slots, may result in an average 9.84 Mbps (illustrated in FIG. 13).

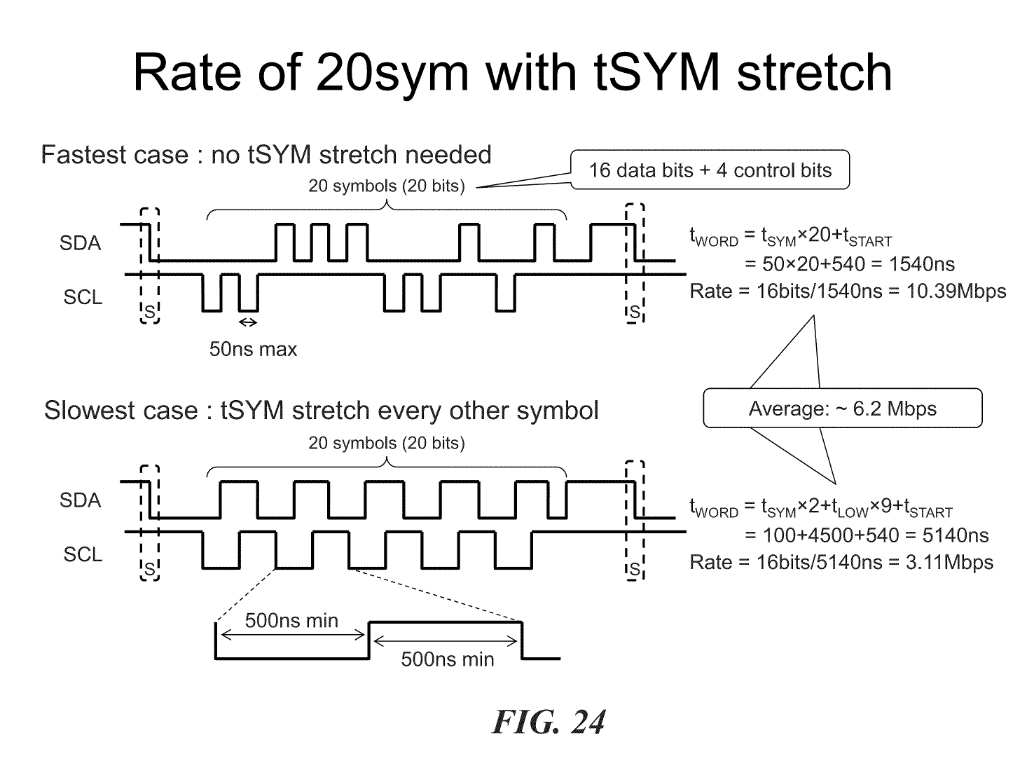

If there are legacy I2C devices coupled to the bus, and at least one of the legacy I2C devices are asynchronously designed and susceptible to metastability, then both symbol slot stretching and prevention of symbols that cause metastable state transitions is implemented. The CCIe devices may then transmit 20 symbols of 2 states per symbol may result in an average 6.2 Mbps (illustrated in FIG. 24).

FIG. 24 illustrates the fastest and slowest rate scenarios for a CCIe transmission, in which 20 symbols (with 2 states per symbol) are used between two START indicators, without including overhead bits.

Various data throughput cases may be possible over the bus.

Case #1: The 12 symbol CCIe can get 23 Mbps if there is no legacy I2C slaves on the bus, or all devices on the same bus can still properly detect START before each CCIe word at tSYM.

Case #2: The 12 symbol CCIe without tSYM stretch for 14 Mbps can be used if all legacy I2C devices on the same bus are synchronously designed with reasonably fast clock that avoids the need for selective stretching of symbol slots as the well as the possibility of a metastable condition.

Case #3: The 12 symbol CCIe with tSYM stretch for average 9.84 Mbps if all legacy I2C devices on the same bus are synchronously designed and free from metastability, but some are not immune to the state machine changes discussed above.

Case #4: The 20 symbol CCIe (with tSYM stretch) is used if both metastability and state machine problem exist.

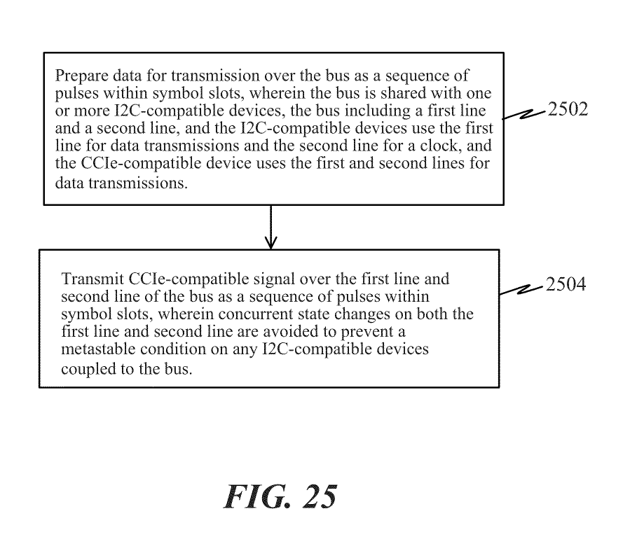

FIG. 25 illustrates a method operational on a CCIe-compatible device for avoiding metastable conditions of I2C-compatible devices coupled to a shared bus. Data is prepared for transmission over the bus as a sequence of pulses within symbol slots, wherein the bus is shared with one or more I2C-compatible devices, the bus including a first line and a second line, and the I2C-compatible devices use the first line for data transmissions and the second line for a clock, and the CCIe-compatible device uses the first and second lines for data transmissions 2502. A CCIe-compatible signal is transmitted over the first line and second line of the bus as a sequence of pulses within symbol slots, wherein concurrent state changes on both the first line and second line are avoided to prevent a metastable condition on any I2C devices coupled to the bus 2504.

### Exemplary CCIe Encoding/Decoding

FIG. 26 is a block diagram illustrating an exemplary method for transcoding of data bits into sequential symbols at a transmitter to embed a clock signal within the sequential symbols. At the transmitter 2602, a sequence of data bits 2604 are converted into a ternary (base 3) number (e.g., where each individual digit of the ternary number is referred to as a “transition number”), and the ternary numbers are converted into sequential symbols which are transmitted over a control data bus that includes a clock line SCL 2612 and a data line SDA 2614.

In one example, an original 20-bits 2604 of binary data is input to a bit-to-transition number converter block 2608 to be converted to a 12-digits ternary number 2609. Each digit of a 12-digits ternary number may represent a “transition number”. Two consecutive digits of a transition number may be the same digit value. Each digit of a transition number is converted into a sequential symbol at a transition-to-symbol block 2610 such that no two consecutive sequential symbols have the same value. Because a transition (e.g., change) is guaranteed at every sequential symbol, such sequential symbol transition may serve to embed a clock signal. Each sequential symbol 2616 is then sent over a two wire physical link (e.g., I2C control data bus comprising a SCL line 2612 and a SDA line 2614).

At a receiver 2620 the process is reversed to convert the sequential symbols back to bits and, in the process, a clock signal is extracted from the sequential symbol transition. The receiver 2620 receives the sequential symbols 2622 over the two wire physical link (e.g., an I2C control data bus comprising a SCL line 2624 and a SDA line 2626). The received sequential symbols 2622 are input into a clock-data recovery (CDR) block 2628 to recover a clock timing and sample the sequential symbols (S). A symbol-to-transition number converter block 2630 then converts each sequential symbol to a transition number, where each transition number represents a digit of a ternary number. Then, a transition number-to-bits converter 2632 converts twelve (12) transition numbers (i.e., a ternary number) to restore twenty (20) bits of original data from the 12 digit ternary number.

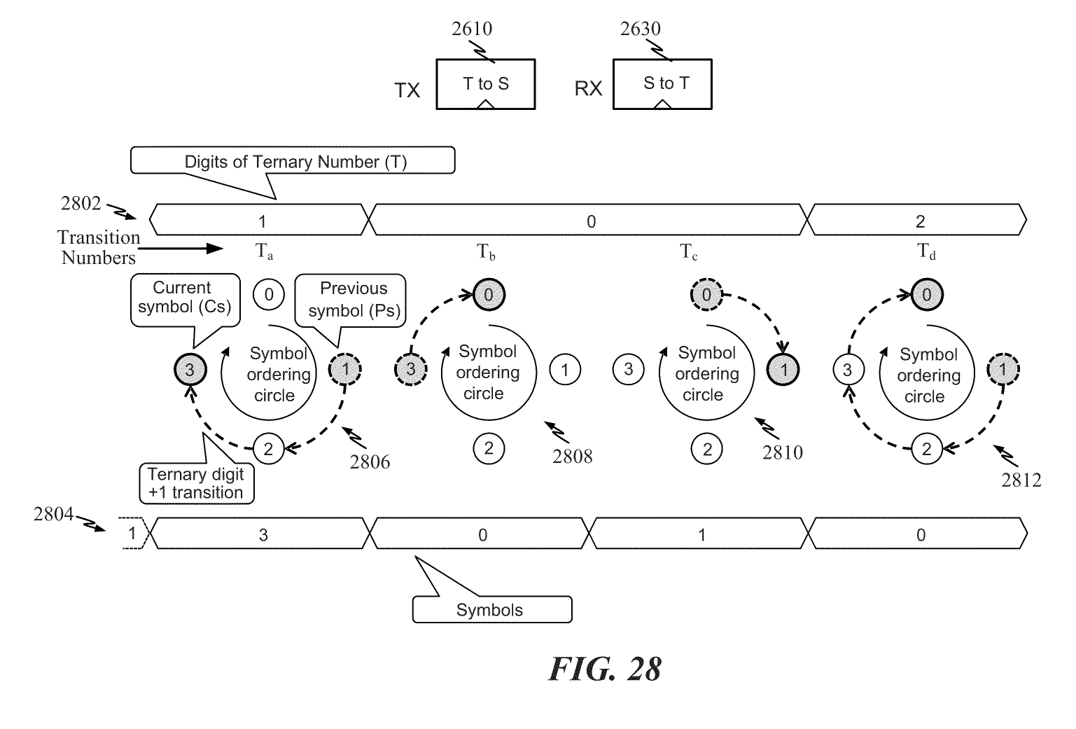

The technique illustrated herein may be used to increase the link rate of a control data bus 102 (FIG. 1) and 208 (FIG. 2) beyond what the I2C standard control data bus provides and is referred hereto as CCIe mode. In one example, a master node/device and/or a slave node/device coupled to the control data bus 102 and 208 may implement transmitters and/or receivers that embed a clock signal within sequential symbol changes/transitions (as illustrated in FIG. 28) in order to achieve higher bit rates over the same control data bus than is possible using a standard I2C control data bus.

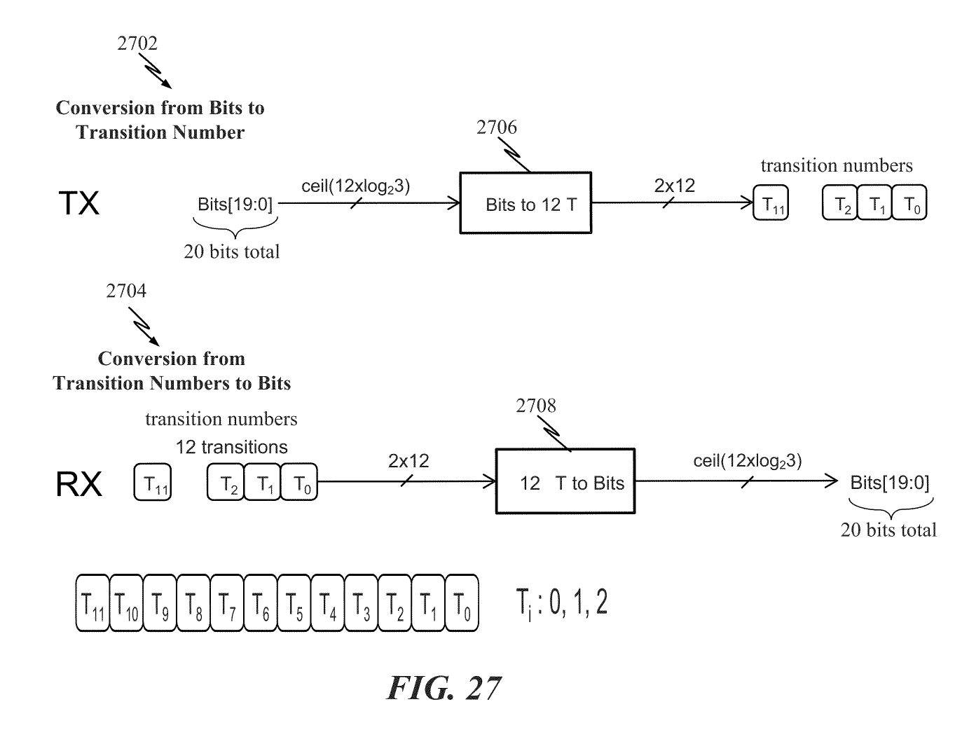

FIG. 27 illustrates an exemplary conversion from bits to transition numbers at a transmitter 2702 and then from transition numbers to bits at a receiver 2704. This example illustrates the transmission for a 2-wire system using 12 transition symbols. The transmitter 2702 feeds binary information, Bits, into a “Bits to 12×T” converter 2706 to generate 12 symbol transition numbers, T0 to T11. The receiver 2704 receives 12 symbols transition numbers, T0 to T11, which are fed into a “12×T to Bits” converter 2708 to retrieve the binary information (Bits). If there are r possible symbol transition states per one T, T0 to T11, 12 transitions can send r¹² different states. For a 2-wire bus, r=2²−1. Consequently, transitions T0 . . . T11 contain data that can have (2²−1)¹² different states. Consequently, r=4−1=3 and the number of states=(4−1)̂12=531441.

In this example for a 2-wire system using 12 symbol transition numbers, it may be assumed that the possible symbol transitions per one T, r is 3 (=2²−1). If the number of symbols in a group is 12, a 12-digit ternary number (base-3 number): T11, T10, . . . , T2, T1, T0, where each Ti: 0, 1, 2, may be used. For example, for {T11, T10, . . . T2, T1, T0}={2, 1, 0, 0, 1, 1, 0, 1, 0, 1, 2, 1}, the ternary number is:

$$2100 \_ 1101 \_ {0121}_{3} ( Ternary number ) = 2 \times {3}^{11} + 1 \times {3}^{10} + 0 \times {3}^{9} + 0 \times {3}^{8} + 1 \times {3}^{7} + 1 \times {3}^{6} + 0 \times {3}^{5} + 1 \times {3}^{4} + 0 \times {3}^{3} + 1 \times {3}^{2} + 2 \times {3}^{1} + 1 \times {3}^{0} = 416356 ( 0 \times 65 A 64 ) .$$

In this manner, 12 transitions numbers may be converted into a number. Note that the ternary number 2100_1101_0121₃ may be used as the transition number, for example, in FIG. 26, so that each integer may be mapped to a sequential symbol and vice versa. When sending 2100_1101_0121₃ in inverse order, the Ts are sent in decreasing order of power, i.e., T11 is the digit to be multiplied by 3¹¹ so it is of the eleventh power and so forth.

The example illustrated in FIG. 26 for a 2-wire system and 12 symbol transition numbers may be generalized to an n-wire system and m symbol transition numbers. If there are r possible symbol transition states per one T, T0 to Tm-1, m transitions can send rm different states, i.e., r=2ⁿ−1. Consequently, transitions T0 . . . Tm-1 contain data that can have (2ⁿ−1)^{m} different states.

FIG. 28 illustrates an exemplary conversion between transition numbers 2802 and sequential symbols 2804. An individual digit of ternary number, base-3 number, also referred to as a transition number, can have one of the three (3) possible digits or states, 0, 1, or 2. While the same digit may appear in two consecutive digits of the ternary number, no two consecutive sequential symbols have the same value. The conversion between a transition number and a sequential symbol guarantees that the sequential symbol always changes (from sequential symbol to sequential symbol) even if consecutive transition numbers are the same.

In one example, the conversion function adds the transition number (e.g., digit of a ternary number) plus 1 to the previous raw sequential symbol value. If the addition results in a number larger than 3, it rolls over from 0, then the result becomes the state number or value for the current sequential symbol.

In a first cycle 2806, a previous sequential symbol (Ps) is 1 when a first transition number (Tₐ) 1 is input, so the first transition number 1 plus 1 is added to the previous sequential symbol (Ps), and the resulting current sequential symbol (Cs) of 3 becomes the current sequential symbol that is sent to the physical link.

In a second (next) cycle 2808, a second transition number (T_{b}) of 0 is input, and the second transition number 0 plus 1 is added to the previous sequential symbol (Ps) of 3. Since the result of the addition (0+1+3) equals 4, is larger than 3, the rolled over number 0 becomes the current sequential symbol (Cs).

In a third cycle 2810, a third transition number (Tₐ) of 0 is input. The conversion logic adds the third transition number 0 plus 1 to the previous sequential symbol (Ps) 0 to generate current sequential symbol (Cs) 1.

In a fourth cycle 2812, a fourth transition number (T_{d}) of 2 is input. The conversion logic adds the fourth transition number (T_{d}) 2 plus 1 to the previous symbol (Ps) 1 to generate current sequential symbol (Cs) 0 (since the result of the addition, 4, is larger than 3, the rolled over number 0 becomes the current sequential symbol).

Consequently, even if two consecutive ternary digits T_{b} and T_{c} have the same number, this conversion guarantees that two consecutive sequential symbols have different state values. Because of this conversion, the guaranteed sequential symbol change or transition in the sequence of symbols 2804 may serve to embed a clock signal, thereby freeing the clock line SCL in an I2C control data bus for data transmissions.

Note that while this example of transition number to sequential number conversions adds a guaranteed number “1” to increment between consecutive sequential symbols, other values may be used in other implementations to guarantee a transition or change between sequential symbols.

Referring again to FIG. 26, at the receiver 2620 the process illustrated in FIG. 28 is reversed to convert the sequential symbols back to bits and, in the process, a clock signal is extracted from the symbol transition. The receiver 2620 receives sequential symbols 2622 over the two wire physical link (e.g., I2C bus comprising a SCL line 2624 and a SDA line 2626). The received sequential symbols 2622 are input into a clock-data recovery (CDR) block 2628 to recover a clock timing and sample the transcoded symbols (S). A symbol-to-transition number converter block 2630 then converts each sequential symbol to a transition number, i.e., which makes up a digit within a ternary number. Then, a transition number-to-bits converter 32 converts 12 transition numbers (i.e., a ternary number) to restore 20 bits of original data from the 12 digit ternary number.

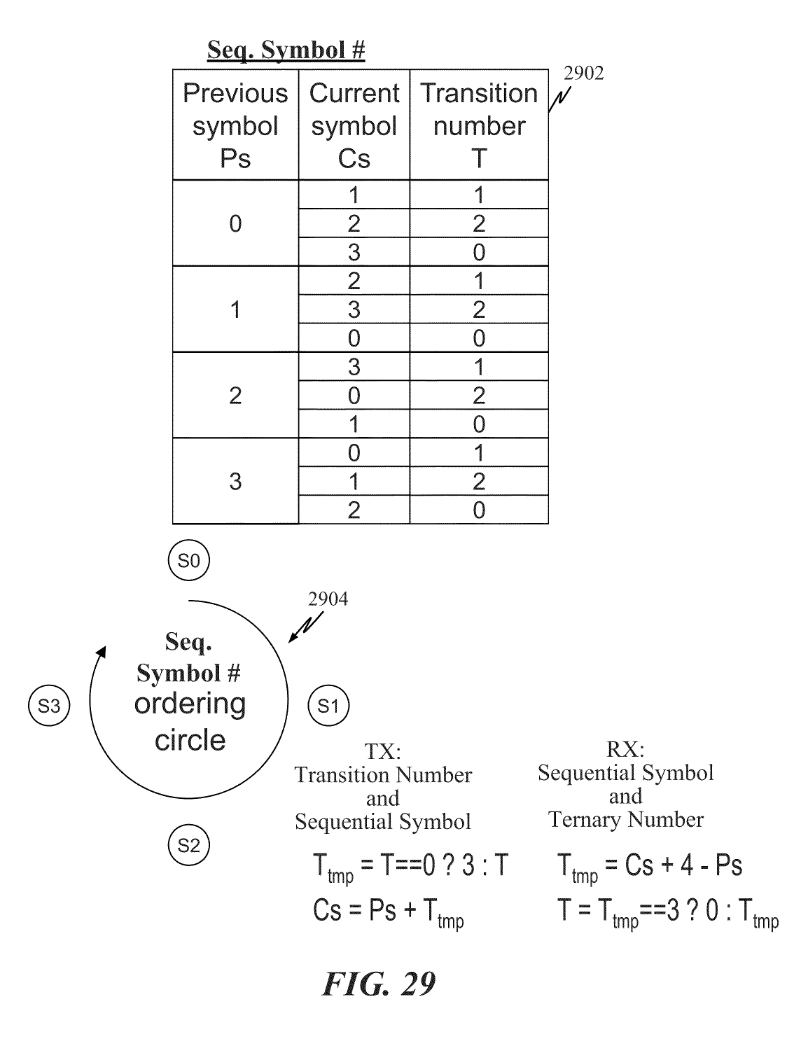

FIG. 29 illustrates the conversion between sequential symbols and transition numbers. This conversion maps each transition from a previous sequential symbol number (Ps) to a current sequential symbol (Cs) to a transition number (T). At the transmitter device, the transition numbers are being converted to sequential symbols. Because of the relative conversion scheme being used, the transition numbers guarantee that no two consecutive sequential symbols 2904 will be the same.

In one example for a 2-wire system, there are 4 raw symbols assigned to 4 sequential symbol S0, S1, S2, and S3. For the 4 sequential symbols, Table 2902 illustrates how a current sequential symbol (Cs) may be assigned based on a previous sequential symbol (Ps) and a temporary transition number Tₜₘₚ based upon the current transition number (T).

In this example, the transition number Cₛ may be assigned according to:

Cs=Ps+Tₜₘₚ

where Tₜₘₚ=T==0 ? 3: T. Alternatively stated, if the current transition number T is equal to zero, the temporary transition number Tₜₘₚ becomes 3, else Tₜₘₚ becomes equal to T. And once Tₜₘₚ is calculated, Cs is set to Ps plus Tₜₘₚ. Moreover, on the receiver end, the logic is reversed to recover T, Tₜₘₚ=Cₛ+4−Pₛ and T=Tₜₘₚ==3 ? 0: Tₜₘₚ.

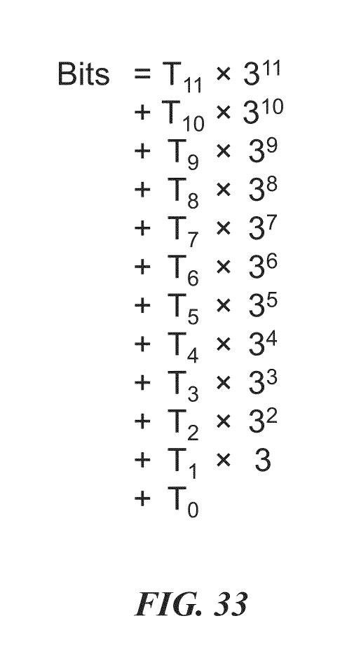

FIG. 33 illustrates a general example of converting a ternary number (base-3 number) to a binary number, where each T in {T11, T10, . . . T2, T1, T0} is a symbol transition number.

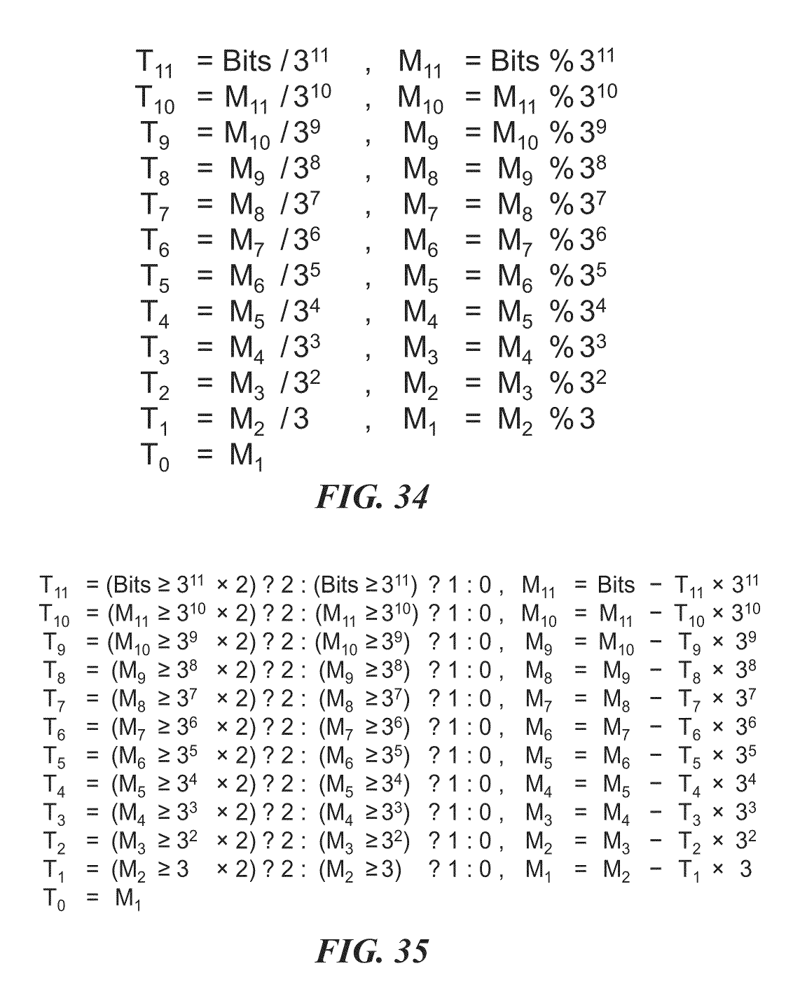

FIG. 34 illustrates an exemplary method for converting a binary number (bits) to a 12 digit ternary number (base-3 number). Each digit can be calculated by dividing the remainder (result of a modulo operation) from a higher digit calculation with 3 to the power of the digit number, discarding decimal points numbers.

FIG. 35 illustrates an example of one possible implementation of the division and the module operations of the FIG. 34, which may be synthesizable by any commercial synthesis tools.

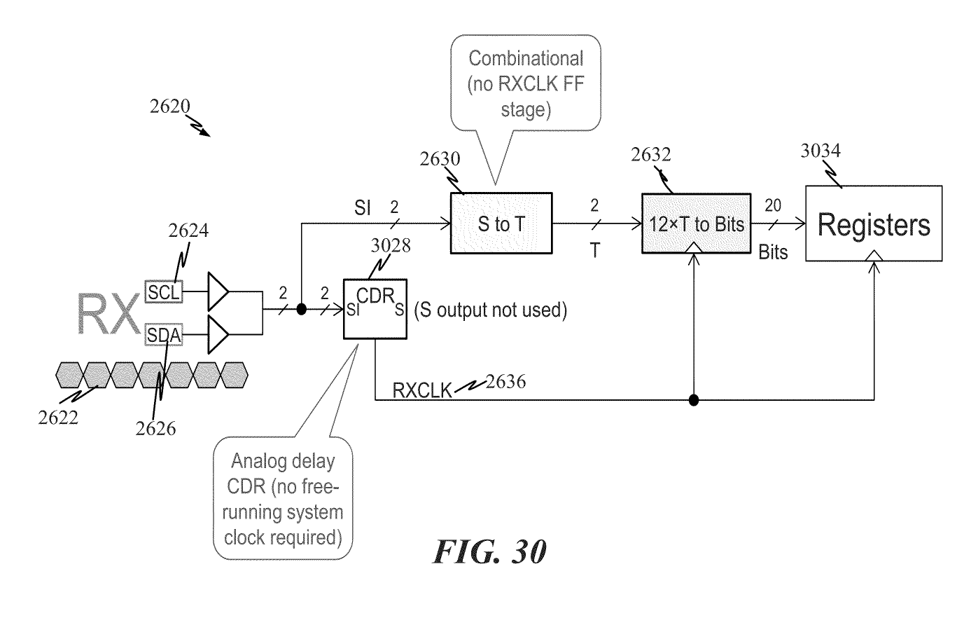

FIG. 30 illustrates the receiver 2620 that is configured to write data received over a shared bus (lines 2624 and 2626 in FIG. 26) to registers 3034 using only a clock recovered from the received data (i.e., no free-running clock is required). A problem exists in attempting to write the received data into registers using only n clock cycles available from the embedded clock. That is, while a clock may be extracted from symbol-to-symbol transitions within the received transmission, an extra clock cycle is needed after the final symbol-to-symbol transition to write the extracted bits into registers for storage. This may be accomplished by having a free-running clock which is undesirable since the master device would need to make sure that the slave device is awake prior to transmission. Alternatively, an analog delay may be introduced as part of the clock extraction circuit. However, under certain conditions the extracted clock is insufficient to both receive the transmitted data and write it to registers.

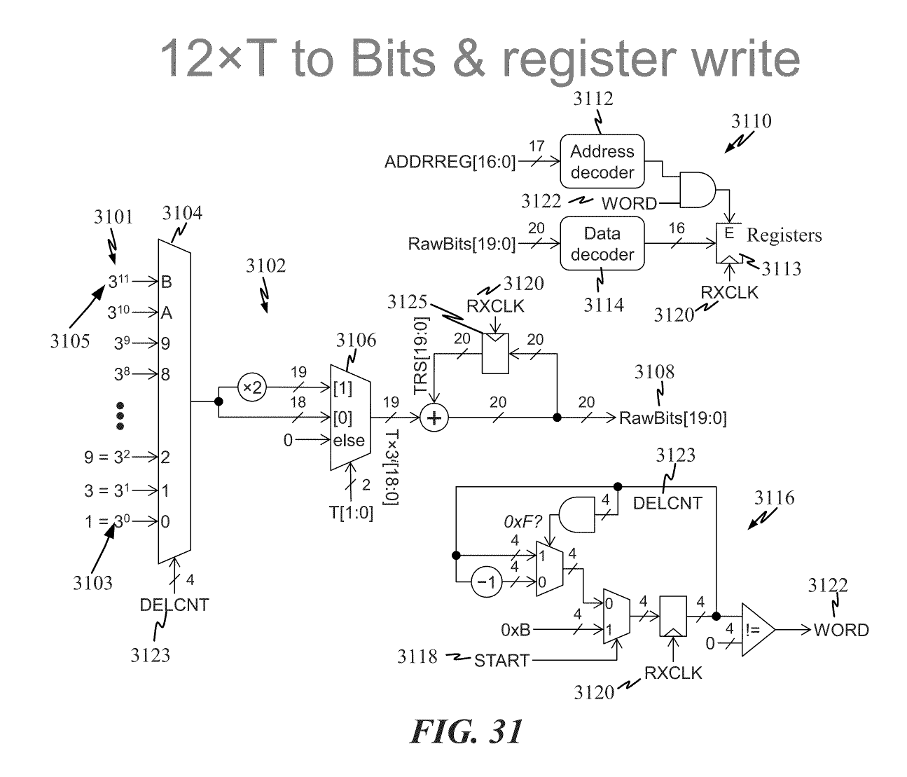

FIG. 31 illustrates circuits for converting a twelve digit ternary number into bits and achieving a register write operation of extracted bits using only the recovered clock. Referring back to FIG. 26, original data of twenty (20) bits is converted into a ternary number, then this transition number is converted (i.e., transcoded) to twelve sequential symbols, and these transcoded symbols are transmitted on the bus. A receiving device (e.g., a slave device) receives the transmission and performs clock recovery and symbol sampling to convert the transcoded symbols back to a ternary number which is then supplied to the circuit in FIG. 31 which converts the ternary number back to the original twenty bit binary data.

A first circuit 3102 is used to extract twenty (20) raw bits 3108 from twelve (12) symbols. These twelve symbols serve as inputs that are converted into ternary weights 3101 which serve as inputs to a single output multiplexer 3104. This allows serialization of the ternary number 3101 so that twenty raw bits 3108 can be extracted. The twenty bits may include sixteen (16) data bits and four (4) control bits. A second multiplexer 3106 functions as a multiplier for a Ti×3̂i operation and is triggered by the 2-bit output from the symbol-to-ternary number block 2630 (FIG. 26). A first flip-flop 3125, triggered by the extracted clock RXCLK 3120, is used to accumulate the transitory bits as the ternary number 3101 is decoded or converted from the ternary weights 3101 to the raw bits 3108. Note that the occurrence of the last symbol S0 is received after the penultimate clock C11 triggers the first flip flop 3125 to output the collected transitory bits to be added with the bits from the last ternary weight 3103 output by a second multiplexer 3106. Consequently, the raw bits 3108 (e.g., data 3122 in FIG. 31) are available after the last symbol S0 is input (after the penultimate clock cycle C11) but before the last clock cycle C12.

A second circuit 3116 may serve to obtain a word marker 3122 when all symbols are received. Upon detecting a start indicator 3118 (e.g., clock 1411 in FIG. 14) of the receiver clock 3122, a down counter DELCNT 3123 starts counting down from 0xB hex (or 12) to zero (0x0 hex at the penultimate clock C11) and then 0xF hex (at the last clock C12). A word marker 3122 is triggered upon the down counter reaching 0x0 hex. This word marker 3122 serves as input to a third circuit 3110 to enable writing data bits into registers. Note that the down counter DELCNT 3123 also serves to select an input signal from the multiplexer 1604, starting with input “B” (first ternary weight 3105) and counting down to input “0” (last ternary weight 3103).

The third circuit 3110 illustrates how the received bits may be written into a second flip-flop or registers 3113. An address decoder 3112 receives seventeen (17) bits of address information and decodes it. Similarly, a data decoder 3114 receives the twenty (20) raw bits 3108 and decodes them to obtain, for example, sixteen (16) data bits (i.e., the four control bits are removed from the twenty raw bits). When the word marker 3122 is triggered and address is decoded, this enables writing of the decoded data (from data decoder 3114) to be stored in flip-flops or register 3113 (e.g., write the sixteen (16) data bits into flip-flops or registers 3113). This third circuit 3110 effectively uses the word marker 3122 to trigger a write to the second flip-flop or registers 3113 on the last clock cycle C12.

On the penultimate clock cycle, the down counter DELCNT 3123 (which started at 0xB hex) reaches 0x0 hex, hence the word marker 3122 goes from low to high. At the last clock cycle C12, the second flip flop or register 3113 is enabled and stores the 16-bit bus now carrying the decoded data bits.

This approach permits storing the received data bits into flip-flops or registers 3113 without a running clock on the slave device. Consequently, the slave device can go into a sleep mode without notifying the master device. That is, no separate mechanism is needed for a master device to be informed when a slave device goes into a sleep mode (e.g., no “slave sleep request” is necessary from a slave device). Because the embedded clock allows the slave device to receive the transmitted bits and the third circuit 3110 generates an additional clock without the need for the slave device to be awake, a master device can write data to a slave device register even when the slave device is asleep or in a sleep mode (e.g., without the need for a free-running clock). In some implementations, the slave device may use the written register data to conditionally wake up part or all its functionality. Therefore, the master device does not have to know whether the slave device is awake or sleeping before sending or writing data to the slave device. Additionally, the slave device may independently enter into a sleep mode without notifying the master device.

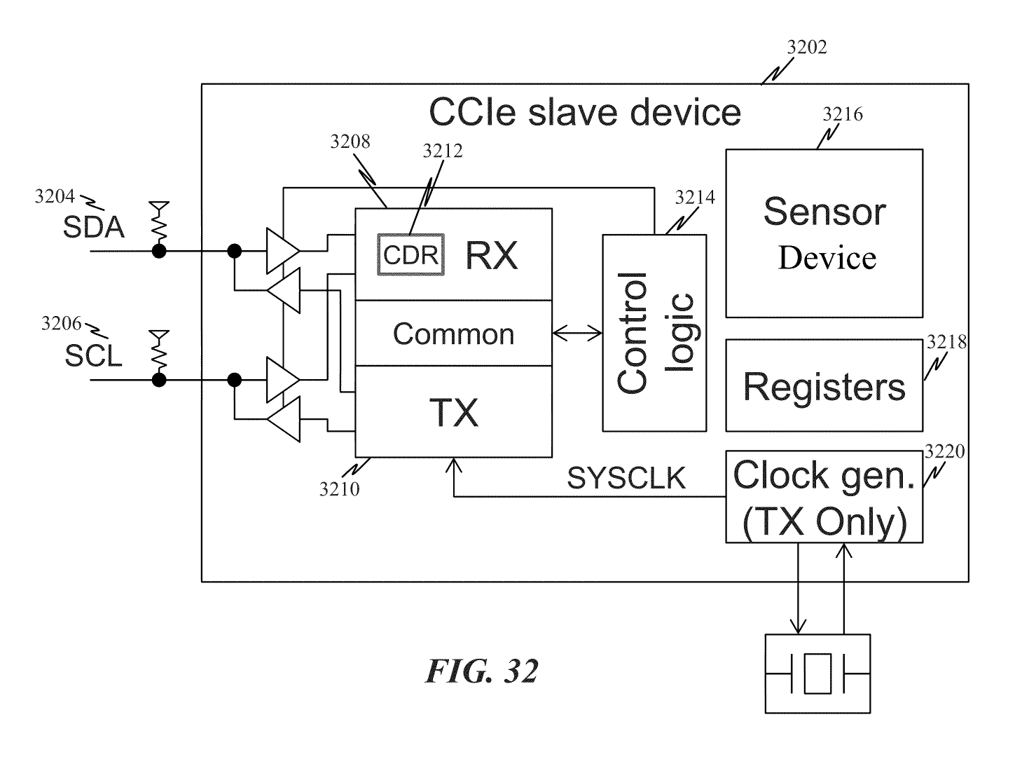

FIG. 32 illustrates an exemplary CCIe slave device 3202 configured to receive a transmission from a shared bus by using a clock extracted from the received transmission and writing data from the transmission without the need for the slave device to be awake. The slave device 3202 includes a receiver circuit 3208 and a transmitter circuit 3210 coupled to a shared bus 3204 and 3206. A control logic 3214 may serve to selectively activate/deactivate the receiver circuit 3208 and/or transmitter circuit 3210 so that the slave device receives or transmits over the shared bus 3204 and 3206. The slave device 3202 may also include a sensor device that captures or collects information for transmission from the slave device.

The receiver circuit 3208 may include a clock data recovery circuit 3212 may extract a receiver clock (RXCLK) from the symbol-to-symbol transitions as illustrated in FIGS. 30 and 31. The receiver circuit 3208 may also include one or more of the first circuit 3102, second circuit 3110, and/or third circuit 3116 (FIG. 31) to decode and extract data received over the shared bus and store such data in registers 3218 using only the extracted clock from the received data transmission and without introducing delays of the extracted clock. Note that the first circuit 3102, second circuit 3110, and/or third circuit 3116 (FIG. 31) may be integrated into one circuit or distributed among different modules or sub-systems.

A clock generator 3220 may be present within the slave device 3202, but it is used only for transmission of data from the slave device and/or other slave device operation, e.g. motion detection or temperature measurement by sensor devices.

In one example, the CCIe device 3202 may include the circuit(s) in FIG. 39 to intelligently stretch CCIe symbols.

In one example, a CCIe device may include an interface (e.g., Rx 3208 and/or Tx 3210) to couple to a multi-mode bus shared with one or more I2C-compatible devices. The bus may include a first line and a second line, wherein in a first mode of operation the first line transmits data and the second line transmits a clock, while in a second mode of operation the first and second lines are both used to transmit data. The transmitter 3210 may transmit data over the bus (SDA line 3204 and SCL line 3206) as a sequence of pulses within symbol slots. In the second mode of operation a transmission period of a first symbol slot is stretched to prevent the I2C-compatible devices from changing into an unpredictable state as a result of a transition from a first pulse to a second pulse.

In one example, the first symbol slot may be stretched so that a perceived period of time without a state change by the bus at the I2C-compatible devices is at least a minimum first threshold period of time. For instance, the first symbol slot may be stretched in the second mode of operation to prevent a state change on the second line, as perceived by the I2C-compatible devices, for a minimum first threshold period of time. The minimum first threshold period of time may correspond to a minimum period of time that I2C-compatible devices can reliably detect state changes over the bus.

In one implementation, two state changes over the bus occurring within less than a second threshold period of time (e.g., a pulse of 50 ns or less) are filtered out by I2C-compatible devices while avoiding stretching of a symbol slot. Additionally, the transmitting CCIe device 3202 may be aware of such short pulse filtering at the I2C devices and intelligently stretches symbols. In particular, the CCIe device 3202 may avoid stretching a symbol if it knows that a subsequent pulse will be filtered out by the receiving I2C devices.

The CCIe device 3202 may also include a processing circuit (e.g., logic circuit or control logic) coupled to the transmitter 3210. The processing circuit may serve to ascertain one or more characteristics of the with one or more I2C-compatible devices coupled to the bus. If all I2C-compatible devices coupled to the bus are synchronously designed with a fast clock, symbol stretching of any symbol slot is avoided (i.e., there is no need for symbol stretching if the I2C device receiver clock is sufficiently fast).

According to another aspect, the CCIe device 3202 may avoid concurrent state changes on both the first line and second line are avoided to prevent a metastable condition on any I2C devices coupled to the bus. If no I2C-compatible devices are coupled to the bus, the transmitter 3210 may be further configured to transmit data signals, according to the second mode, over the first line and second line of the bus as a sequence of pulses within symbol slots, but using concurrent state changes on both the first line and second line.

In one example, if all I2C-compatible devices coupled the bus are synchronously designed with an internal clock, the transmitter 3210 may be further configured to transmit data signals, according to the second mode, over the first line and second line of the bus as a sequence of pulses within symbol slots, but using concurrent state changes on both the first line and second line.

In one example, where no I2C devices are coupled to the bus, the transmitter 3210 transmits data signals with concurrent state changes over the first and second lines using 12 symbols of 3 states per symbol. In one example, where I2C devices are coupled to the bus, the transmitter 3210 transmits data signals that avoid concurrent state changes on the first and second lines using 20 symbols of 2 states per symbol.

One or more of the components, steps, features, and/or functions illustrated in the Figures may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in the Figures may be configured to perform one or more of the methods, features, or steps described in the Figures. The novel algorithms described herein may also be efficiently implemented in software and/or embedded in hardware.

In addition, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices, and/or other machine readable mediums for storing information. The term “machine readable medium” includes, but is not limited to portable or fixed storage devices, optical storage devices, wireless channels and various other mediums capable of storing, containing, or carrying instruction(s) and/or data.

Furthermore, embodiments may be implemented by hardware, software, firmware, middleware, microcode, or any combination thereof. When implemented in software, firmware, middleware, or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A device, comprising:
an interface to couple to a multi-mode bus shared with one or more I2C-compatible devices, the bus including a first line and a second line, wherein in a first mode of operation the first line transmits data and the second line transmits a clock, while in a second mode of operation the first and second lines are both used to transmit data; and
a transmitter for transmitting data over the bus as a sequence of pulses within symbol slots, wherein the second mode of operation a transmission period of a first symbol slot is stretched to prevent the I2C-compatible devices from changing into an unpredictable state as a result of a transition from a first pulse to a second pulse.

2. The device of claim 1, wherein the first symbol slot is stretched so that a perceived period of time without a state change by the bus at the I2C-compatible devices is at least a minimum first threshold period of time.

3. The device of claim 1, wherein the first symbol slot is stretched in the second mode of operation to prevent a state change on the second line, as perceived by the I2C-compatible devices, for a minimum first threshold period of time.

4. The device of claim 3, wherein the minimum first threshold period of time corresponds to a minimum period of time that I2C-compatible devices can reliably detect state changes over the bus.

5. The device of claim 3, wherein two state changes over the bus occurring within less than a second threshold period of time are filtered out by I2C-compatible devices while avoiding stretching of a symbol slot.

6. The device of claim 1, further comprising:
a processing circuit coupled to the transmitter and configured to ascertain one or more characteristics of the with one or more I2C-compatible devices coupled to the bus.

7. The device of claim 6, wherein if all I2C-compatible devices on the bus are synchronously designed with a fast clock, symbol stretching of any symbol slot is avoided.

8. The device of claim 1, wherein concurrent state changes on both the first line and second line are avoided to prevent a metastable condition on any I2C devices coupled to the bus.

9. The device of claim 1, wherein if no I2C-compatible devices are coupled to the bus, the transmitter is further configured to transmit data signals, according to the second mode, over the first line and second line of the bus as a sequence of pulses within symbol slots, but using concurrent state changes on both the first line and second line.

10. The device of claim 1, wherein if all I2C-compatible devices coupled the bus are synchronously designed with an internal clock, the transmitter is further configured to transmit data signals, according to the second mode, over the first line and second line of the bus as a sequence of pulses within symbol slots, but using concurrent state changes on both the first line and second line.

11. The device of claim 10, wherein the data signals with concurrent state changes are transmitted over the first and second lines using 12 symbols of 3 states per symbol.

12. The device of claim 10, wherein the data signals that avoid concurrent state changes on the first and second lines using 20 symbols of 2 states per symbol.

13. A method operational on a device, comprising:
preparing data for transmission over a multi-mode bus as a sequence of pulses within symbol slots, the bus shared with one or more I2C-compatible devices, wherein in a first mode of operation the first line transmits data and the second line transmits a clock, while in a second mode of operation the first and second lines are both used to transmit data; and
transmitting data over the bus as a sequence of pulses within symbol slots, wherein the second mode of operation a transmission period of a first symbol slot is stretched to prevent the I2C-compatible devices from changing into an unpredictable state as a result of a transition from a first pulse to a second pulse.

14. The method of claim 13, wherein the first symbol slot is stretched so that a perceived period of time without a state change by the bus at the I2C-compatible devices is at least a minimum first threshold period of time.

15. The method of claim 13, wherein the first symbol slot is stretched in the second mode of operation to prevent a state change on the second line, as perceived by the I2C-compatible devices, for a minimum first threshold period of time.

16. The method of claim 15, wherein the minimum first threshold period of time corresponds to a minimum period of time that I2C-compatible devices can reliably detect state changes over the bus.

17. The method of claim 15, wherein two state changes over the bus occurring within less than a second threshold period of time are filtered out by I2C-compatible devices while avoiding stretching of a symbol slot.

18. The method of claim 13, wherein concurrent state changes on both the first line and second line are avoided to prevent a metastable condition on any I2C devices coupled to the bus.

19. The method of claim 13, wherein if no I2C-compatible devices are coupled to the bus, further comprising:
transmitting data signals, according to the second mode, over the first line and second line of the bus as a sequence of pulses within symbol slots, but using concurrent state changes on both the first line and second line.

20. A device, comprising:
means for preparing data for transmission over a multi-mode bus as a sequence of pulses within symbol slots, the bus shared with one or more I2C-compatible devices, wherein in a first mode of operation the first line transmits data and the second line transmits a clock, while in a second mode of operation the first and second lines are both used to transmit data; and
means for transmitting data over the bus as a sequence of pulses within symbol slots, wherein the second mode of operation a transmission period of a first symbol slot is stretched to prevent the I2C-compatible devices from changing into an unpredictable state as a result of a transition from a first pulse to a second pulse.

21. A device, comprising:
a multi-mode bus including a first line and a second line, wherein in a first mode of operation the first line transmits data and the second line transmits a clock, while in a second mode of operation the first and second lines are both used to transmit data;
one or more I2C-compatible devices coupled to the bus and configured to transmit over the bus according to the first mode;
a first device, distinct from the one or more I2C-compatible devices, coupled to the bus and configured to transmit data signals according to the second mode over the first line and second line of the bus as a sequence of pulses within symbol slots, wherein the second mode of operation a transmission period of a first symbol slot is stretched to prevent the I2C-compatible devices from changing into an unpredictable state as a result of a transition from a first pulse to a second pulse.

22. The device of claim 21, wherein the first symbol slot is stretched so that a perceived period of time without a state change by the bus at the I2C-compatible devices is at least a minimum first threshold period of time.

23. The device of claim 22, wherein the first symbol slot is stretched in the second mode of operation to prevent a state change on the second line, as perceived by the I2C-compatible devices, for a minimum first threshold period of time.

24. The device of claim 23, wherein the minimum first threshold period of time corresponds to a minimum period of time that I2C-compatible devices can reliably detect state changes over the bus.

25. The device of claim 23, wherein two state changes over the bus occurring within less than a second threshold period of time are filtered out by I2C-compatible devices while avoiding stretching of a symbol slot.

26. The device of claim 21, wherein if no I2C-compatible devices are coupled to the bus, the first device is further configured to transmit data signals, according to the second mode, over the first line and second line of the bus as a sequence of pulses within symbol slots, but using concurrent state changes on both the first line and second line.

27. The device of claim 26, wherein the data signals concurrent state changes are transmitted over the first and second lines using 12 symbols of 3 states per symbol.

28. The device of claim 26, wherein the data signals that avoid concurrent state changes are transmitted on the first and second lines using 20 symbols of 2 states per symbol.
